(19) United States
(12) Patent Application Publication
(10) Pub. No.: US 2023/0220255 A1
(43) Pub. Date: Jul. 13, 2023

(54) INCOMPLETE POLYGONAL SHAPED ABRASIVE PARTICLES, METHODS OF MANUFACTURE AND ARTICLES CONTAINING THE SAME

(71) Applicant: 3M INNOVATIVE PROPERTIES COMPANY, St. Paul, MN (US)

(72) Inventors: Yuyang Liu, St. Paul, MN (US); Fay T. Salmon, Eden Prairie, MN (US); Maiken Givot, St. Paul, MN (US); Mark A. Lukowski, St. Paul, MN (US); Dwight D. Erikson, Woodbury, MN (US); Negus B. Adefris, St. Paul, MN (US)

(21) Appl. No.: 18/000,521

(22) PCT Filed: May 19, 2021
(86) PCT No.: PCT/IB2021/054311

§ 371 Date: Dec. 2, 2022

Related U.S. Application Data
(60) Provisional application No. 62/704,951, filed on Jun. 4, 2020.

(51) Int. Cl. C09K 3/14

(52) U.S. Cl. CPC C09K 3/1409

(57) ABSTRACT

Various embodiments disclosed relate to an incomplete shaped abrasive particle, articles containing the same, and methods of manufacture.

### BACKGROUND

Abrasive particles and abrasive articles including the abrasive particles are useful for abrading, finishing, or grinding a wide variety of materials and surfaces in the manufacturing of goods. As such, there continues to be a need for improving the cost, performance, or life of abrasive particles or abrasive articles.

### SUMMARY OF THE DISCLOSURE

Various embodiments disclosed relate to an incomplete shaped abrasive particle, formed from a mold with a predetermined shape. The incomplete shaped abrasive particle has a vertex and at least two arms and a portion of the predetermined shape.

Various further embodiments disclosed relate to a method of making an incomplete shaped abrasive particle. The method includes disposing an abrasive particle precursor composition in a mold cavity having a predetermined shape. The method further includes drying the abrasive particle precursor to form the incomplete shaped abrasive particle.

Various further embodiments disclosed relate to an abrasive article. The abrasive article includes a backing. The abrasive article further includes a plurality of incomplete shaped abrasive particles attached to the backing.

Various further embodiments disclosed relate to a method of making an abrasive article. The method includes adhering partially shaped abrasive particles to the backing.

Various further embodiments disclosed relate to a method of using an abrasive article. The abrasive article includes a backing. The abrasive article further includes a plurality of shaped abrasive particles attached to an article. The method includes contacting the shaped abrasive particles with a workpiece. The method further includes moving at least one of the abrasive article and the workpiece relative to each other in a direction of use. The method further includes removing a portion of the workpiece.

There are many reasons to use the shaped abrasive particles and articles including the shaped abrasive particles described herein including the following non-limiting reasons. The improved adhesion may result in reduced shelling as compared to solid polygonal shaped particles. Additionally, incomplete polygonal shaped particles may also aid in controlling mineral breakdown during use. Burning may also be prevented. Further, costs may be reduced using incomplete tetrahedral particles. Another feature of incomplete shaped particles is that the empty interior space can be filled with grinding aids, for example lubricants.

### BRIEF DESCRIPTION OF THE FIGURES

The drawings illustrate generally, by way of example, but not by way of limitation, various embodiments discussed in the present document.

FIG. 1 illustrates a regular tetrahedron which may serve as a reference for some embodiments herein.

FIGS. 2A-G illustrate incomplete polyhedral shaped abrasive particles in accordance with some embodiments herein.

FIG. 3 illustrates an example abrasive article in accordance with embodiments herein.

FIG. 4 illustrates a method of making an incomplete polyhedral shaped abrasive particle in accordance with embodiments herein.

FIGS. 5A-5C illustrate another method of making an incomplete tetrahedral shaped abrasive particle in accordance with embodiments herein.

FIGS. 6A-6F illustrate curved polyhedral shaped abrasive particles in accordance with embodiments herein.

FIG. 7 illustrates curved polyhedral shaped abrasive particles precisely placed on a surface in an embodiment herein.

FIGS. 8A and 8B illustrate a method of making a curved polyhedral shaped abrasive particle in embodiments herein.

FIGS. 9-14 illustrate examples of incomplete tetrahedral shaped abrasive particles in accordance with embodiments herein.

FIGS. 15-17 illustrate example abrasive articles incorporating incomplete tetrahedral shaped abrasive particles in accordance with embodiments herein.

FIGS. 18A-18B illustrates a comparative abrasive article comprising tetrahedral shaped particles.

FIG. 19 illustrates example performance data for an example and a comparative sample.

FIGS. 20A and 20B illustrate comparative edge sharpness examples and a comparative example.

FIG. 21 illustrate example performance data for an example and a comparative sample.

FIGS. 22 and 23 illustrate curved polyhedral shaped abrasive particles in embodiments herein.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “shaped abrasive particle”, means an abrasive particle with at least a portion of the abrasive particle having a predetermined shape that is replicated from a mold cavity used to form the shaped precursor abrasive particle. Except in the case of abrasive shards (e.g. as described in US Patent Application Publication Nos. 2009/0169816 and 2009/0165394), the shaped abrasive particle will generally have a predetermined geometric shape that substantially replicates the mold cavity that was used to form the shaped abrasive particle. Shaped abrasive particle as used herein excludes abrasive particles obtained by a mechanical crushing operation.

Then, “incomplete shaped abrasive particles” as used herein refer to abrasive particles formed from a mold cavity with a predetermined shape. The incomplete shaped abrasive particles are formed and replicated from the mold such that a substantially reproduceable incomplete shaped particle results. For example, the incomplete shaped abrasive articles may be formed by only partially filling a mold cavity with a predetermined shape. In another example, the mold cavity is completely filled, but evaporation and/or drying results in a reduced mass of the resulting particle, only exhibiting an incomplete negative image of the mold.

Suitable examples for incomplete shaped abrasive particles include geometric shapes having at least one vertex include polygons (including equilateral, equiangular, star-shaped, regular and irregular polygons), lense-shapes, lune-shapes, circular shapes, semicircular shapes, oval shapes, circular sectors, circular segments, drop-shapes and hypocycloids (for example super elliptical shapes).

For the purposes of this invention geometric shapes are also intended to include regular or irregular polygons or stars wherein one or more edges (parts of the perimeter of the face) can be arcuate (either of towards the inside or towards the outside, with the first alternative being preferred). Hence, for the purposes of this invention, triangular shapes also include three-sided polygons wherein one or more of the edges (parts of the perimeter of the face) can be arcuate, i.e., the definition of triangular extends to spherical triangles and the definition of quadrilaterals extends to superellipses. The second side may have (and preferably is) a second face. The second face may have a perimeter of a second geometric shape.

At least some embodiments herein concern an incomplete shaped particle that is an incomplete tetrahedral shaped particle. However, it is expressly contemplated that incomplete shaped particles can be based on other polygonal structures.

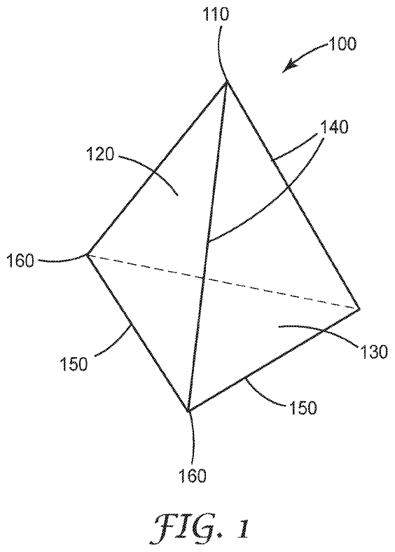

FIG. 1 illustrates a regular tetrahedron. The term ‘tetrahedron’ as used throughout the application and is understood to refer to a triangular pyramid, such as that illustrated in FIG. 1, with four corners that define four planar triangular faces.

Tetrahedron 100 is a polyhedron with four faces 120. A regular tetrahedron is defined as having four identical triangular faces, six straight edges and four vertex corners. While some embodiments described herein concern a regular tetrahedron, it is also expressly contemplated that other tetrahedrons are expressly contemplated. Additionally, while incomplete tetrahedrons are discussed as one example embodiment of the present invention, other incomplete polyhedrons are also expressly contemplated, as illustrated herein.

In the context of abrasive particles incorporated into an abrasive article, often each particle is designed with an intended base 130, configured to interface with a backing of the abrasive article for example, and a cutting point 110. Additionally, a tetrahedral shaped abrasive particle also has three cutting edges 140. Base 130 is defined as having three edges 150 and three corners 160. However, one benefit of tetrahedron shaped particles is that each face 120 can serve as a base 130. Therefore, while edges 150 are discussed in the context of being edges of a base face 130, it is expressly contemplated that edges 150 and vertices 160 may also be designed to serve as faces 120 and/or cutting vertex 110.

However, as illustrated in FIG. 1, because each vertices 160 is equivalent, a cutting direction and performance of a particle with shape 100 is substantially the same no matter which vertex 110 faces away from a backing. It is possible that improved cutting performance could be achieved from sharper cutting tips, more tips per particle, and/or curved particle walls or arms that can serve similarly to shovels to remove produced swarf during an abrasive operation.

The discussion of regular tetrahedron 100 is presented for ease in understanding only, and is not intended to limit the discussion of embodiments described herein.

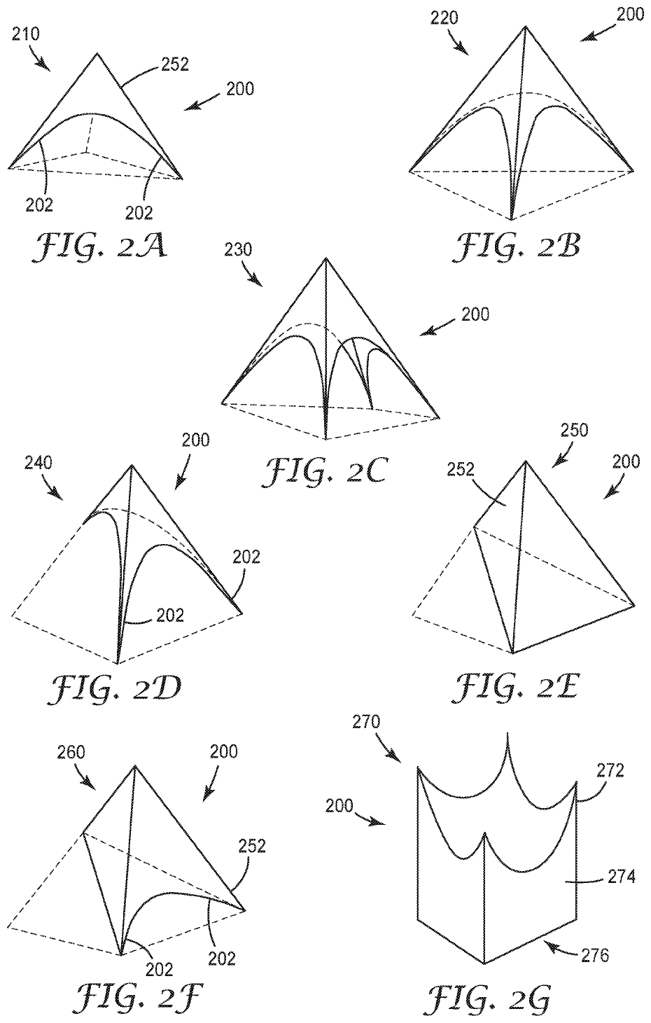

FIGS. 2A-2G illustrate incomplete polyhedral shaped abrasive particles in accordance with some embodiments of the present invention. In some embodiments, an incomplete polyhedron-shaped particle may provide better abrasive function within an abrasive article than its complete counterpart. FIGS. 2A-2F illustrate six example incomplete polyhedral shapes in accordance with embodiments described herein. These, and other potential shapes may be created using methods described herein. FIGS. 2A-2F are presented as examples only, as many other potential shapes are also possible and intended to be included in the present disclosure. Each of the shapes presented in FIGS. 2A-2F will be discussed with reference to FIG. 1 for understanding.

FIG. 2A illustrates an incomplete tetrahedral shaped particle 2000, with edges 252 ending in one or more arms 202. FIG. 2B illustrates an incomplete tetrahedral shaped particle 220, with a vertex and three edges, each connected to a corner of the theoretical base of a tetrahedron. FIG. 2C illustrates an incomplete pentahedral shaped particle with four edges, each ending in a sharp point.

While FIGS. 2A, 2B and 2C illustrate incomplete shaped abrasive particles with edges of substantially the same lengths, it is also expressly contemplated that incomplete shaped particles can form with edges of different lengths, either on purpose, due to breakage from the removal or drying process, or for other reasons. For example, FIG. 2D illustrates an incomplete tetrahedral shaped particle 240 with three edges, only two of which form arms 202 extending to a theoretical base.

FIG. 2E illustrates an incomplete tetrahedral shaped particle 250 with two complete edges 140 ending on corners 160. Incomplete tetrahedral shaped particle 250 also has one complete face that extends to the base edge.

FIG. 2F illustrates an incomplete tetrahedral shaped particle 260 with at least two partial faces. While incomplete tetrahedral shaped particles 210, 220, 230 and 240 illustrate embodiments where longer arms 202 are formed, particle 260 illustrates a more complete partial face 252, and comparatively shorter arms 202. In one embodiment, incomplete shaped particles are at least about 20% by weight of a comparative complete shaped particle. In another embodiment, incomplete shaped particles are at least about 25%, 30%, 35%, 40%, 45% or 50% by weight of a comparative complete shaped particle. More complete particles may have a longer effective lifespan than less complete particles.

Notably, none of incomplete particles 210-260 have a complete base opposing the vertex, and all are missing at least a portion of an interior of the theoretical complete shape. In one embodiment, each of incomplete particles 210-260 are made using a mold with precisely shaped cavities. In one embodiment, particles 210-260 are formed when each cavity, in one embodiment, is only partially filled with a precursor solution and allowed to dry. As the solvent evaporates, a partially complete abrasive particle is formed. In some embodiments, for example as illustrated by FIGS. 2A, 2B, 2C, 2D and 2F, the precursor solution formed a meniscus during the drying process, resulting in an arc-shaped partial face.

Additionally, while FIGS. 2A-2F illustrate incomplete shaped abrasive particles with planar faces, it is also possible to form incomplete shaped abrasive particles with non-planar faces. For example, a mold with grooves may be used that creates an incomplete tetrahedral shaped abrasive particle with ridges. Additionally, drying conditions may be used to create concave or convex faces as well.

FIG. 2G illustrates an example of an incomplete cubic shaped abrasive particle 270. Incomplete cubic shaped abrasive particle 270 may have between one and four arms 272 and one or more incomplete faces 274. Instead of a point, incomplete shaped cubic abrasive particle 270 has a base 276. Base 276 may be closer to a center of gravity of incomplete cubic shaped abrasive particle 270 than arms 272, causing particle 270 to be more likely to self-orient with one or more arms 272 facing away from a backing.

Incomplete polygonal shaped particles, such as those illustrated in FIGS. 2A-2G, may provide a variety of benefits over other solid polygonal shaped abrasive particles. The presence of arms, for example arms 202, 272 allow for better adhesion of the incomplete polygonal particles within an abrasive article structure. The improved adhesion may result in reduced shelling as compared to solid polygonal shaped particles. Additionally, incomplete polygonal shaped particles may also aid in controlling mineral breakdown during use. Burning may also be prevented or reduced during abrasive operations. The open structures of the incomplete abrasive particles offer better anti-loading performance than that of comparative complete particles. The term “loading” is used in the sandpaper industry to refer to a product that can be clogged or gummed up due to residue filling up the inter-spaces between abrasive particles with small particles of the material being sanded, making the sandpaper work much harder or to even ruin it (end lifespan). Further, costs may be reduced using incomplete particles. Another feature of incomplete shaped particles is that the empty interior space can be filled with grinding aids, for example lubricants.

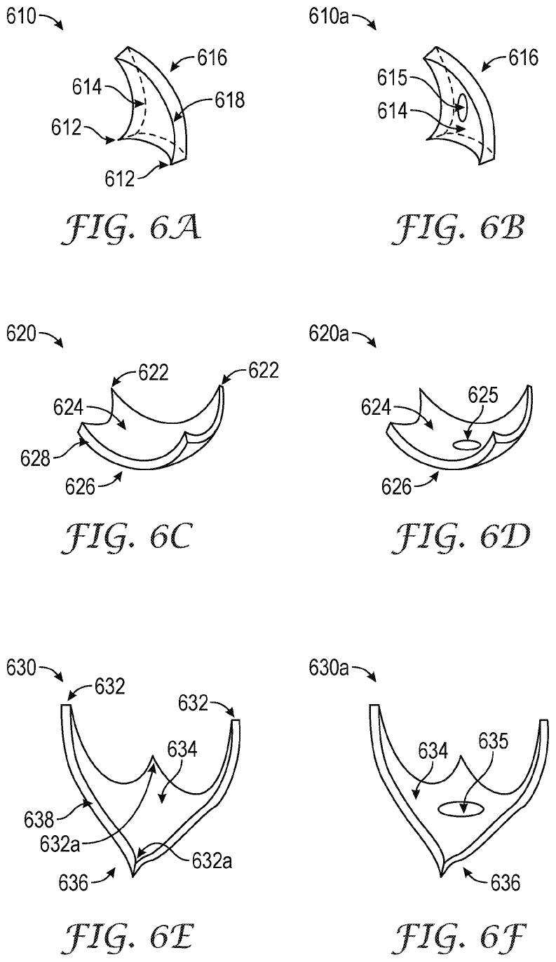

Discussed herein are several examples of incomplete shaped abrasive particles that may provide some of the described benefits when incorporated in an abrasive article, for example a coated abrasive article, a bonded abrasive article, or another abrasive article such as a bristle brush or other structure. Additionally, curved abrasive particles are also illustrated, for example in FIGS. 6A-6F that may exhibit similar benefits to the incomplete abrasive particles illustrated in FIG. 2.

Discussed herein are several methods of forming incomplete and curved abrasive particles. However, the particles described in FIGS. 2A-2F and 6A-6F may be formed using other suitable methods, and the methods described herein may be utilized to form other shaped particles.

FIG. 3 illustrates an example abrasive article on accordance with an embodiment of the present invention. In one embodiment, abrasive article 300 is a nonwoven abrasive article, comprising nonwoven fibers 310. Nonwoven abrasive article 300 is made of nonwoven fibers 310, incomplete polygonal shaped abrasive particles 320, and a binding agent (not shown) to hold particles 320 within nonwoven fibers 310. As illustrated in FIG. 3, arms 330 may assist in holding abrasive particles 320 within nonwoven abrasive article 300. Additionally, where arms 330 do not directly contact a nonwoven fiber 310, they may provide additional cutting edges or vertices, increasing the abrasive capabilities of nonwoven abrasive article 300, and/or the working lifespan of nonwoven abrasive article 300.

While FIG. 3 illustrates a nonwoven abrasive article, it is also expressly contemplated that the incomplete polygonal shaped articles described herein may provide benefits when incorporated into other abrasive articles, for example when included in a grinding wheel or as part of a coated disc or belt.

The method includes disposing an abrasive particle precursor composition in a mold cavity conforming to the negative image of the intended polygonal shape forming the basis for the incomplete polygonal shaped abrasive particle (e.g. a tetrahedron shaped mold cavity for the particles illustrated in FIG. 2A-2F or a cube shaped mold for the particle illustrated in FIG. 2G). The method further includes drying the abrasive particle precursor to form the incomplete shaped abrasive particle. In some embodiments the abrasive particle can optionally be subjected to a firing process.

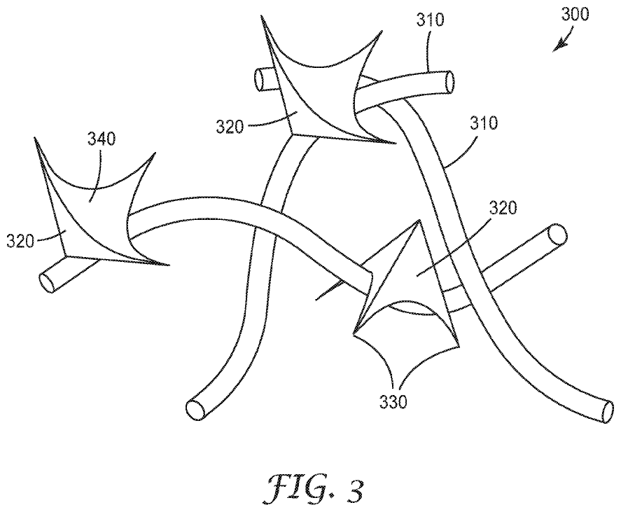

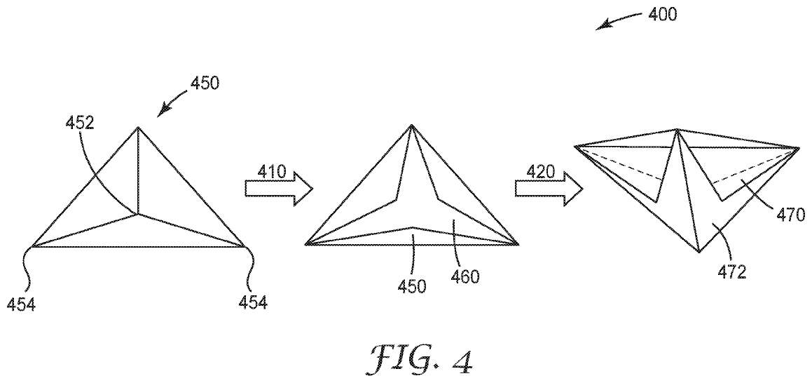

FIG. 4 illustrates a method of making an incomplete tetrahedral shaped particle in accordance with an embodiment of the present invention. Method 400 illustrates a process for making an incomplete tetrahedral shaped particle 472, however method 400 may also be useful for making other incomplete polygonal shaped particles.

In step 410, a mold 450 is filled with a precursor slurry 460. Mold 450 contains a center 452 that is deeper than corners 454 which may be even with a top edge of mold 450, in one embodiment. However, in other embodiments, mold 450 is designed with a different number of corners 454 with a different geometric relationship to mold center 452. For example, while center 452 is illustrated as a vertex in FIG. 4, it is also contemplated that center 452 may include a plane, for example in an embodiment where incomplete polygonal shaped abrasive particle is based on a truncated pyramid or a quadrilateral.

In step 420, mold 450 and precursor slurry 460 undergo a drying process where a solvent is removed from precursor slurry 460, resulting in a precursor incomplete tetrahedral shaped abrasive particle 472. Reference numeral 470 illustrates a portion of volume lost by the drying process, for example due to the evaporation of a solvent within slurry 460.

FIG. 4 illustrates, in step 410, an embodiment where mold 450 is only partially filled with precursor slurry 460. However, in another embodiment, mold 450 is completely filled with precursor slurry 460, and the drying process of 420 is responsible for forming arms of incomplete tetrahedral shaped abrasive particle 472, for example by evaporation or other solvent removal process.

While not shown, precursor incomplete tetrahedral shaped abrasive particles 472 can undergo additional processing steps before being incorporated in an abrasive article, as discussed in greater detail below.

Method 400 allows for a plurality of incomplete polygonal shaped particles to be formed, for example by using polygonal shaped molds and controlling the drying rates of solvent from a precursor slurry. Variation of the shape of mold 450 can allow for abrasive particles of other incomplete polygonal shapes. For example, mold 450 could have four corners 454, allowing for an incomplete pyramidal shaped abrasive particle. The number of arms on an incomplete polygonal shaped abrasive particle, therefore, can be controlled in part by the number of corners 454 present in mold 450.

Additionally, faces of an incomplete polygonal shaped abrasive particle can also be influenced by the shape of mold 450, in addition to drying conditions. For example, a planar mold 450 can be used to manufacture an incomplete polygonal shaped abrasive particle with planar faces or, depending on drying conditions, concave faces. Molds with planar, concave and convex surfaces are all expressly contemplated. Further, the faces of an incomplete polygonal shaped abrasive particle can also be smooth or textured based on whether texture is present in mold 450. For example, if mold 450 has ridges, the resulting incomplete polygonal shaped abrasive particle will have ridges, in one embodiment.

Methods for making shaped abrasive particles having at least one sloping sidewall are for example described in US Patent Application Publication Nos. 2010/0151196 and 2009/0165394. Methods for making shaped abrasive particles having an opening are for example described in US Patent Application Publication No. 2010/0151201. and 2009/0165394. Methods for making shaped abrasive particles having grooves on at least one side are for example described in US Patent Application Publication No. 2010/0146867. Methods for making dish-shaped abrasive particles are for example described in US Patent Application Publication Nos. 2010/0151195 and 2009/0165394. Methods for making shaped abrasive particles with low Roundness Factor are for example described in US Patent Application Publication No. 2010/0319269. Methods for making shaped abrasive particles with at least one fractured surface are for example described in US Patent Application Publication Nos. 2009/0169816 and 2009/0165394. Methods for making abrasive particles wherein the second side has a vertex (for example, dual tapered abrasive particles) or a ridge line (for example, roof shaped particles) are for

As illustrated in FIGS. 2A-2G, in different embodiments, incomplete polygonal shaped abrasive particles can have different length arms, and different sized faces as compared to the shape of the original mold 450. The amount of a face present in an incomplete polygonal shaped abrasive particle can be affected in several ways—by the presence of a meniscus during drying, by varying the amount of solvent in a slurry, or by changing the way the slurry interacts with the wall of the mold. A higher solvent content will result in a greater reduction in size. Depending on how the precursor solution interacts with the mold material, a larger or smaller meniscus may form, resulting in a larger or smaller face. An incomplete polygonal shaped abrasive particle can be achieved by fully filling the cavities with slurry first and then removing the desired amount of slurry with a variety of ways, such as with a brush, a roller, a blanket, or pressurized air. For example, fully filling the cavities with slurry and then removing 50% of the slurry with a brush, resulting in forming an incomplete particle with 50% less volume, compared with a regular complete particle. Additives such as surfactant, release aid agent, wetting agent can also change the way the slurry interacts with the wall of the mold, resulting in forming particles with different arm length and face size. Temperature can also change the way the slurry interacts with the wall of the mold, resulting in forming particles with different arm length and face size. For example, slurry with promoted temperature (40° C. or higher) wets the walls of the mold better in comparison with slurry at room temperature (15-20° C.), resulting in forming incomplete particle with larger face and arms.

The final shape of an incomplete polygonal shaped abrasive particle depends on several factors including the shape of the mold, the amount of solvent in the precursor slurry, and the drying conditions.

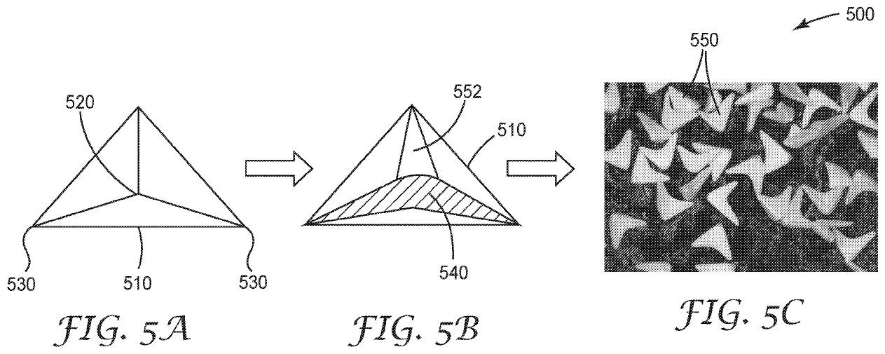

FIGS. 5A-5C illustrate another method of making an incomplete tetrahedral shaped particle in accordance with an embodiment of the present invention. Method 500 is similar to method 400, described above. A mold 510, defined by a center 520 and corners 530, is filled with a slurry 540. However, mold 510 is shaped such that portion 552 remains empty. Leaving a portion 552 of mold 510 empty may result in incomplete tetrahedral shaped abrasive particles 550 with two arms instead of the three expected, based on the tetrahedral shape of mold 510. Method 500, therefore, expands on the number of additional polygonal shapes available than through method 400 alone.

Incomplete polygonal shaped abrasive particles can be formed from many suitable materials or combinations of materials. For example, incomplete polygonal shaped abrasive particles can include a ceramic material or a polymeric material. If incomplete polygonal shaped abrasive particles include a ceramic material, the ceramic material can include alpha alumina, sol-gel derived alpha alumina, or a mixture thereof. Other suitable materials include a fused aluminum oxide, a heat-treated aluminum oxide, a ceramic aluminum oxide, a sintered aluminum oxide, a silicon carbide material, a titanium diboride, a boron carbide, a tungsten carbide, a titanium carbide, a diamond, a cubic boron nitride, a garnet, a fused alumina-zirconia, a cerium oxide, a zirconium oxide, a titanium oxide or a combination thereof.

Examples of suitable abrasive particle compositions for abrasive particles herein include: fused aluminum oxide; heat-treated aluminum oxide; white fused aluminum oxide; ceramic aluminum oxide materials such as those commercially available under the trade designation 3M CERAMIC ABRASIVE GRAIN from 3M Company, St. Paul, Minn.; brown aluminum oxide; blue aluminum oxide; silicon carbide (including green silicon carbide); titanium diboride; boron carbide; tungsten carbide; garnet; titanium carbide; diamond; cubic boron nitride; garnet; fused alumina zirconia; iron oxide; chromia; zirconia; titania; tin oxide; quartz; feldspar; flint; emery; sol-gel-derived abrasive particles; and combinations thereof. Of these, molded sol-gel derived alpha alumina abrasive particles are preferred in many embodiments. Abrasive material that cannot be processed by a sol-gel route may be molded with a temporary or permanent binder to form shaped precursor particles which are then sintered to form shaped abrasive particles, for example, as described in U.S. Pat. Appln. Publ. No. 2016/0068729 A1 (Erickson et al.).

Examples of sol-gel-derived abrasive particles and methods for their preparation can be found in U.S. Pat. Nos. 4,314,827 (Leitheiser et al.); 4,623,364 (Cottringer et al.); 4,744,802 (Schwabel), 4,770,671 (Monroe et al.); and 4,881,951 (Monroe et al.). It is also contemplated that the abrasive particles could include abrasive agglomerates such, for example, as those described in U.S. Pat. Nos. 4,652,275 (Bloecher et al.) or 4,799,939 (Bloecher et al.). In some embodiments, first and/or abrasive particles may be surface-treated with a coupling agent (e.g., an organosilane coupling agent) or other physical treatment (e.g., iron oxide or titanium oxide) to enhance adhesion of the abrasive particles to the binder (e.g., make and/or size layer). The abrasive particles may be treated before combining them with the corresponding binder precursor, or they may be surface treated in situ by including a coupling agent to the binder.

Preferably, abrasive particles described herein are ceramic abrasive particles such as, for example, sol-gel-derived polycrystalline alpha alumina particles. Abrasive particles composed of crystallites of alpha alumina, magnesium alumina spinel, and a rare earth hexagonal aluminate may be prepared using sol-gel precursor alpha alumina particles according to methods described in, for example, U.S. Pat. No. 5,213,591 (Celikkaya et al.) and U.S. Pat. Appln. Publ. Nos. 2009/0165394 A1 (Culler et al.) and 2009/0169816 A1 (Erickson et al.).

Alpha alumina-based triangular abrasive particles can be made according to well-known multistep processes. Briefly, the method includes the steps of making either a seeded or non-seeded sol-gel alpha alumina precursor dispersion that can be converted into alpha alumina; filling one or more mold cavities having the desired outer shape of the abrasive particle with the sol-gel, drying the sol-gel to form precursor triangular abrasive particles; removing the precursor abrasive particles from the mold cavities; calcining the precursor abrasive particles to form calcined, precursor abrasive particles, and then sintering the calcined, precursor abrasive particles to form the first and/or second set of abrasive particles.

Further details concerning methods of making sol-gel-derived abrasive particles can be found in, for example, U.S. Pat. Nos. 4,314,827 (Leitheiser); 5,152,917 (Pieper et al.); 5,435,816 (Spurgeon et al.); 5,672,097 (Hoopman et al.); 5,946,991 (Hoopman et al.); 5,975,987 (Hoopman et al.); and 6,129,540 (Hoopman et al.); and in U.S. Publ. Pat. Appln. No. 2009/0165394 A1 (Culler et al.).

In some preferred embodiments, the abrasive particles are precisely-shaped in that individual abrasive particles will have a shape that is essentially the shape of the portion of the cavity of a mold or production tool in which the particle precursor was dried, prior to optional calcining and sintering.

Abrasive particles used in the present disclosure can typically be made using tools (i.e., molds) cut using precision machining, which provides higher feature definition than other fabrication alternatives such as, for example, stamping or punching.

Examples of sol-gel-derived alpha alumina (i.e., ceramic) abrasive particles can be found in U.S. Pat. Nos. 5,201,916 (Berg); 5,366,523 (Rowenhorst (Re 35,570)); and 5,984,988 (Berg). Details concerning such abrasive particles and methods for their preparation can be found, for example, in U.S. Pat. Nos. 8,142,531 (Adefris et al.); 8,142,891 (Culler et al.); and 8,142,532 (Erickson et al.); and in U.S. Pat. Appl. Publ. Nos. 2012/0227333 (Adefris et al.); 2013/0040537 (Schwabel et al.); and 2013/0125477 (Adefris).

Examples of slurry derived alpha alumina abrasive particles can be found in WO 2014/070468, published on May 8, 2014. Slurry derived particles may be formed from a powder precursor, such as alumina oxide powder. The slurry process may be advantageous for larger particles that can be difficult to make using sol-gel techniques.

The abrasive particles may undergo a sintering process, such as the process described in U.S. Pat. No. 10,400,146, issued on Sep. 3, 2019, for example. However, other processing techniques are expressly contemplated.

Incomplete polygonal shaped abrasive particles that include a polymeric material can be characterized as soft abrasive particles. The soft shaped abrasive particles described herein can include any suitable material or combination of materials. For example, the soft shaped abrasive particles can include a reaction product of a polymerizable mixture including one or more polymerizable resins. The one or more polymerizable resins are chosen from a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, a drying oil, or mixtures thereof. The polymerizable mixture can include additional components such as a plasticizer, an acid catalyst, a cross-linker, a surfactant, a mild-abrasive, a pigment, a catalyst and an antibacterial agent. Softer PSG particles, with Mohs hardness' between 2.0 and 5.0, that can be used for non-scratch applications, can be made according to methods described in WO 2019/215539, published on Nov. 14, 2019.

Where multiple components are present in the polymerizable mixture, those components can account for any suitable weight percentage of the mixture. For example, the polymerizable resin or resins, may be in a range of from about 35 wt % to about 99.9 wt % of the polymerizable mixture, about 40 wt % to about 95 wt %, or less than, equal to, or greater than about 35 wt %, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or about 99.9 wt %.

If present, the cross-linker may be in a range of from about 2 wt % to about 60 wt % of the polymerizable mixture, from about 5 wt % to about 10 wt %, or less than, equal to, or greater than about 2 wt %, 3, 4, 5, 6, 7, 8, 9, 10, 11, 12, 13, 14, or about 15 wt %. Examples of suitable cross-linkers include a cross-linker available under the trade designation CYMEL 303 LF, of Allnex USA Inc., Alpharetta, Ga., USA; or a cross-linker available under the trade designation CYMEL 385, of Allnex USA Inc., Alpharetta, Ga., USA.

If present, the mild-abrasive may be in a range of from about 5 wt % to about 65 wt % of the polymerizable mixture, about 10 wt % to about 20 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or about 65 wt %. Examples of suitable mild-abrasives include a mild-abrasive available under the trade designation MINSTRON 353 TALC, of Imerys Talc America, Inc., Three Forks, Mont., USA; a mild-abrasive available under the trade designation USG TERRA ALBA NO.1 CALCIUM SULFATE, of USG Corporation, Chicago, Ill., USA; Recycled Glass (40-70 Grit) available from ESCA Industries, Ltd., Hatfield, Pa., USA, silica, calcite, nepheline, syenite, calcium carbonate, or mixtures thereof.

If present, the plasticizer may be in a range of from about 5 wt % to about 40 wt % of the polymerizable mixture, about 10 wt % to about 15 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or about 40 wt %. Examples of suitable plasticizers include acrylic resins or styrene butadiene resins. Examples of acrylic resins include an acrylic resin available under the trade designation RHOPLEX GL-618, of DOW Chemical Company, Midland, Mich., USA; an acrylic resin available under the trade designation HYCAR 2679, of the Lubrizol Corporation, Wickliffe, Ohio, USA; an acrylic resin available under the trade designation HYCAR 26796, of the Lubrizol Corporation, Wickliffe, Ohio, USA; a polyether polyol available under the trade designation ARCOL LG-650, of DOW Chemical Company, Midland, Mich., USA; or an acrylic resin available under the trade designation HYCAR 26315, of the Lubrizol Corporation, Wickliffe, Ohio, USA. An example of a styrene butadiene resin includes a resin available under the trade designation ROVENE 5900, of Mallard Creek Polymers, Inc., Charlotte, N.C., USA.

If present, the acid catalyst may be in a range of from 1 wt % to about 20 wt % of the polymerizable mixture, about 5 wt % to about 10 wt %, or less than, equal to, or greater than about 1 wt %, 2, 3, 4, 5, 6, 7, 8, 9, 10, 11, 12, 13, 14, 15, 16, 17, 18, 19, or about 20 wt %. Examples of suitable acid catalysts include a solution of aluminum chloride or a solution of ammonium chloride.

If present, the surfactant can be in a range of from about 0.001 wt % to about 15 wt % of the polymerizable mixture about 5 wt % to about 10 wt %, less than, equal to, or greater than about 0.001 wt %, 0.01, 0.5, 1, 2, 3, 4, 5, 6, 7, 8, 9, 10, 11, 12, 13, 14, or about 15 wt %. Examples of suitable surfactants include a surfactant available under the trade designation GEMTEX SC-85-P, of Innospec Performance Chemicals, Salisbury, N.C., USA; a surfactant available under the trade designation DYNOL 604, of Air Products and Chemicals, Inc., Allentown, Pa., USA; a surfactant available under the trade designation ACRYSOL RM-8W, of DOW Chemical Company, Midland, Mich., USA; or a surfactant available under the trade designation XIAMETER AFE 1520, of DOW Chemical Company, Midland, Mich., USA.

If present, the antimicrobial agent may be in a range of from 0.5 wt % to about 20 wt % of the polymerizable mixture, about 10 wt % to about 15 wt %, or less than, equal to, or greater than about 0.5 wt %, 1, 2, 3, 4, 5, 6, 7, 8, 9, 10, 11, 12, 13, 14, 15, 16, 17, 18, 19, or about 20 wt %. An example of a suitable antimicrobial agent includes zinc pyrithione.

If present, the pigment may be in a range of from about 0.1 wt % to about 10 wt % of the polymerizable mixture, about 3 wt % to about 5 wt %, less than, equal to, or greater than about 0.1 wt %, 0.2, 0.4, 0.6, 0.8, 1, 1.5, 2, 2.5, 3, 3.5, 4, 4.5, 5, 5.5, 6, 6.5, 7, 7.5, 8, 8.5, 9, 9.5, or about 10 wt %. Examples of suitable pigments include a pigment dispersion available under the trade designation SUNSPERSE BLUE 15, of Sun Chemical Corporation, Parsippany, N.J., USA; a pigment dispersion available under the trade designation SUNSPERSE VIOLET 23, of Sun Chemical Corporation, Parsippany, N.J., USA; a pigment dispersion available under the trade designation SUN BLACK, of Sun Chemical Corporation, Parsippany, N.J., USA; or a pigment dispersion available under the trade designation BLUE PIGMENT B2G, of Clariant Ltd., Charlotte, N.C., USA.

In addition to the materials already described, at least one magnetic material may be included within or coated to incomplete polygonal shaped abrasive particles. Examples of magnetic materials include iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (about 85:9:6 by weight) marketed as Sendust alloy; Heusler alloys (e.g., Cu₂MnSn); manganese bismuthide (also known as Bismanol); rare earth magnetizable materials such as gadolinium, dysprosium, holmium, europium oxide, alloys of neodymium, iron and boron (e.g., Nd₂Fe₁₄B), and alloys of samarium and cobalt (e.g., SmCo₅); MnSb; MnOFe₂O₃; Y₃Fe₅O₁₂; CrO₂; MnAs; ferrites such as ferrite, magnetite; zinc ferrite; nickel ferrite; cobalt ferrite, magnesium ferrite, barium ferrite, and strontium ferrite; yttrium iron garnet; and combinations of the foregoing. In some embodiments, the magnetizable material is an alloy containing 8 to 12 weight percent aluminum, 15 to 26 wt % nickel, 5 to 24 wt % cobalt, up to 6 wt % copper, up to 1% titanium, wherein the balance of material to add up to 100 wt % is iron. In some other embodiments, a magnetizable coating can be deposited on an abrasive particle 100 using a vapor deposition technique such as, for example, physical vapor deposition (PVD) including magnetron sputtering.

Including these magnetizable materials can allow incomplete polygonal shaped abrasive particles to be responsive a magnetic field. Any of incomplete polygonal shaped abrasive particles can include the same material or include different materials.

Alignment of abrasive particles may be accomplished using electrostatic coating or magnetic coating, as described in PCT Pat. Appl. Publ. Nos. WO2018/080703 (Nelson et al.), WO2018/080756 (Eckel et al.), WO2018/080704 (Eckel et al.), WO2018/080705 (Adefris et al.), WO2018/080765 (Nelson et al.), WO2018/080784 (Eckel et al.), WO2018/136271 (Eckel et al.), WO2018/134732 (Nienaber et al.), WO2018/080755 (Martinez et al.), WO2018/080799 (Nienaber et al.), WO2018/136269 (Nienaber et al.), WO2018/136268 (Jesme et al.), WO2019/207415 (Nienaber et al.), WO2019/207417 (Eckel et al.), WO2019/207416 (Nienaber et al.), and U.S. Provisional Nos. 62/914,778 filed on Oct. 14, 2019 and 62/875,700 filed Jul. 18, 2019, and 62/924,956, filed Oct. 23, 2019.

An incomplete polygonal shaped abrasive particle is a monolithic abrasive particle. As shown, incomplete polygonal shaped abrasive particles are free of a binder and are not an agglomeration of abrasive particles held together by a binder or other adhesive material.

Incomplete polygonal shaped abrasive particles can be formed in many suitable manners for example, the incomplete polygonal shaped abrasive particles can be made according to a multi-operation process. The process can be carried out using any material or precursor dispersion material. Briefly, for embodiments where incomplete polygonal shaped abrasive particles are monolithic ceramic particles, the process can include the operations of making either a seeded or non-seeded precursor dispersion that can be converted into a corresponding (e.g., a boehmite sol-gel that can be converted to alpha alumina); filling one or more mold cavities having the desired outer shape of incomplete polygonal shaped abrasive particles with a precursor dispersion; drying the precursor dispersion to form precursor shaped abrasive particle; removing the precursor incomplete polygonal shaped abrasive particles from the mold cavities; calcining the precursor incomplete polygonal shaped abrasive particles to form calcined, precursor incomplete polygonal shaped abrasive particles; and then sintering the calcined, precursor incomplete polygonal shaped abrasive particles to form incomplete polygonal shaped abrasive particles. The process will now be described in greater detail in the context of alpha-alumina-containing incomplete polygonal shaped abrasive particles. In other embodiments, the mold cavities may be filled with a melamine to form melamine shaped abrasive particles.

The process can include the operation of providing either a seeded or non-seeded dispersion of a precursor that can be converted into ceramic. In examples where the precursor is seeded, the precursor can be seeded with an oxide of an iron (e.g., FeO). The precursor dispersion can include a liquid that is a volatile component. In one example, the volatile component is water. The dispersion can include a sufficient amount of liquid for the viscosity of the dispersion to be sufficiently low to allow filling mold cavities and replicating the mold surfaces, but not so much liquid as to cause subsequent removal of the liquid from the mold cavity to be prohibitively expensive. In one example, the precursor dispersion includes from 2 percent to 90 percent by weight of the particles that can be converted into ceramic, such as particles of aluminum oxide monohydrate (boehmite), and at least 10 percent by weight, or from 50 percent to 70 percent, or 50 percent to 60 percent, by weight, of the volatile component such as water. Conversely, the precursor dispersion in some embodiments contains from 30 percent to 50 percent, or 40 percent to 50 percent solids by weight.

Examples of suitable precursor dispersions include zirconium oxide sols, vanadium oxide sols, cerium oxide sols, aluminum oxide sols, and combinations thereof. Suitable aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL” and “DISPAL”, both available from Sasol North America, Inc., or “HIQ-40” available from BASF Corporation. These aluminum oxide monohydrates are relatively pure; that is, they include relatively little, if any, hydrate phases other than monohydrates, and have a high surface area.

The physical properties of the resulting incomplete polygonal shaped abrasive particles can generally depend upon the type of material used in the precursor dispersion. As used herein, a “gel” is a three-dimensional network of solids dispersed in a liquid.

The precursor dispersion can contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, such as water-soluble salts. They can include a metal-containing compound and can be a precursor of an oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the precursor dispersion can be varied.

The introduction of a modifying additive or precursor of a modifying additive can cause the precursor dispersion to gel. The precursor dispersion can also be induced to gel by application of heat over a period of time to reduce the liquid content in the dispersion through evaporation. The precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina.

A peptizing agent can be added to the precursor dispersion to produce a more stable hydrosol or colloidal precursor dispersion. Suitable peptizing agents are monoprotic acids or acid compounds such as acetic acid, hydrochloric acid, formic acid, and nitric acid. Multiprotic acids can also be used, but they can rapidly gel the precursor dispersion, making it difficult to handle or to introduce additional components. Some commercial sources of boehmite contain an acid titer (such as absorbed formic or nitric acid) that will assist in forming a stable precursor dispersion.

The precursor dispersion can be formed by any suitable means; for example, in the case of a sol-gel alumina precursor, it can be formed by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired.

A further operation can include providing a mold having at least one mold cavity, or a plurality of cavities formed in at least one major surface of the mold. In some examples, the mold is formed as a production tool, which can be, for example, a belt, a sheet, a continuous web, a coating roll such as a rotogravure roll, a sleeve mounted on a coating roll, or a die. In one example, the production tool can include polymeric material. Examples of suitable polymeric materials include thermoplastics such as polyesters, polycarbonates, poly(ether sulfone), poly(methyl methacrylate), polyurethanes, polyvinylchloride, polyolefin, polystyrene, polypropylene, polyethylene or combinations thereof, or thermosetting materials. In one example, the entire tooling is made from a polymeric or thermoplastic material. In another example, the surfaces of the tooling in contact with the precursor dispersion while the precursor dispersion is drying, such as the surfaces of the plurality of cavities, include polymeric or thermoplastic materials, and other portions of the tooling can be made from other materials. A suitable polymeric coating can be applied to a metal tooling to change its surface tension properties, by way of example.

A polymeric or thermoplastic production tool can be replicated off a metal master tool. The master tool can have the inverse pattern of that desired for the production tool. The master tool can be made in the same manner as the production tool. In one example, the master tool is made out of metal (e.g., nickel) and is diamond-turned. In one example, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that can distort the thermoplastic production tool, limiting its life.

Access to cavities can be from an opening in the top surface or bottom surface of the mold. In some examples, the cavities can extend for the entire thickness of the mold. Alternatively, the cavities can extend only for a portion of the thickness of the mold. In one example, the top surface is substantially parallel to the bottom surface of the mold with the cavities having a substantially uniform depth. At least one side of the mold, the side in which the cavities are formed, can remain exposed to the surrounding atmosphere during the step in which the volatile component is removed.

The cavities have a specified three-dimensional shape to make incomplete polygonal shaped abrasive particles. The depth dimension is equal to the perpendicular distance from the top surface to the lowermost point on the bottom surface. The depth of a given cavity can be uniform or can vary along its length and/or width. The cavities of a given mold can be of the same shape or of different shapes.

A further operation involves filling the cavities in the mold with the precursor dispersion (e.g., by a conventional technique). In some examples, a knife roll coater or vacuum slot die coater can be used. A mold release agent can be used to aid in removing the particles from the mold if desired. Examples of mold release agents include oils such as peanut oil or mineral oil, fish oil, silicones, polytetrafluoroethylene, zinc stearate, and graphite. In general, a mold release agent such as peanut oil, in a liquid, such as water or alcohol, is applied to the surfaces of the production tooling in contact with the precursor dispersion such that from about 0.1 mg/in² (0.6 mg/cm²) to about 3.0 mg/in² (20 mg/cm²), or from about 0.1 mg/in² (0.6 mg/cm²) to about 5.0 mg/in² (30 mg/cm²), of the mold release agent is present per unit area of the mold when a mold release is desired. In some embodiments, the top surface of the mold is coated with the precursor dispersion. The precursor dispersion can be pumped onto the top surface.

In a further operation, a scraper or leveler bar can be used to force the precursor dispersion fully into the cavity of the mold. The remaining portion of the precursor dispersion that does not enter the cavity can be removed from the top surface of the mold and recycled. In some examples, a small portion of the precursor dispersion can remain on the top surface, and in other examples the top surface is substantially free of the dispersion. The pressure applied by the scraper or leveler bar can be less than 100 psi (0.6 MPa), or less than 50 psi (0.3 MPa), or even less than 10 psi (60 kPa). In some examples, no exposed surface of the precursor dispersion extends substantially beyond the top surface.

A further operation involves removing the volatile component to dry the dispersion. The volatile component can be removed by fast evaporation rates. In some examples, removal of the volatile component by evaporation occurs at temperatures above the boiling point of the volatile component. An upper limit to the drying temperature often depends on the material the mold is made from. For polypropylene tooling, the temperature should be less than the melting point of the plastic. In one example, for a water dispersion of from about 40 to 50 percent solids and a polypropylene mold, the drying temperatures can be from about 90° C. to about 165° C., or from about 105° C. to about 150° C., or from about 105° C. to about 120° C. Higher temperatures can lead to improved production speeds but can also lead to degradation of the polypropylene tooling, limiting its useful life as a mold.

During drying, the precursor dispersion shrinks, often causing retraction from the cavity walls. For example, if the cavities have planar walls, then the resulting incomplete polygonal shaped abrasive particles can tend to have at least three concave major sides. It is presently discovered that by making the cavity walls concave (whereby the cavity volume is increased) it is possible to obtain incomplete polygonal shaped abrasive particles that have at least three substantially planar major sides. The degree of concavity generally depends on the solids content of the precursor dispersion.

A further operation involves removing resultant precursor incomplete polygonal shaped abrasive particles from the mold cavities. The precursor incomplete polygonal shaped abrasive particles can be removed from the cavities by using the following processes alone or in combination on the mold: gravity, vibration, ultrasonic vibration, vacuum, or pressurized air to remove the particles from the mold cavities.

The precursor incomplete polygonal shaped abrasive particles can be further dried outside of the mold. If the precursor dispersion is dried to the desired level in the mold, this additional drying step is not necessary. However, in some instances it can be economical to employ this additional drying step to minimize the time that the precursor dispersion resides in the mold. The precursor incomplete polygonal shaped abrasive particles will be dried from 10 to 480 minutes, or from 120 to 400 minutes, at a temperature from 50° C. to 160° C., or 120° C. to 150° C.

A further operation involves calcining the precursor incomplete polygonal shaped abrasive particles. During calcining, essentially all the volatile material is removed, and the various components that were present in the precursor dispersion are transformed into metal oxides. The precursor incomplete polygonal shaped abrasive particles are generally heated to a temperature from 400° C. to 800° C. and maintained within this temperature range until the free water and over 90 percent by weight of any bound volatile material are removed. In an optional step, it can be desirable to introduce the modifying additive by an impregnation process. A water-soluble salt can be introduced by impregnation into the pores of the calcined, precursor incomplete polygonal shaped abrasive particles. Then the precursor incomplete polygonal shaped abrasive particles are pre-fired again.

A further operation can involve sintering the calcined, precursor incomplete polygonal shaped abrasive particles to form particles 100. In some examples where the precursor includes rare earth metals, however, sintering may not be necessary. Prior to sintering, the calcined, precursor incomplete polygonal shaped abrasive particles are not completely densified and thus lack the desired hardness to be used as incomplete polygonal shaped abrasive particles. Sintering takes place by heating the calcined, precursor incomplete polygonal shaped abrasive particles to a temperature of from 1000° C. to 1650° C. The length of time for which the calcined, precursor incomplete polygonal shaped abrasive particles can be exposed to the sintering temperature to achieve this level of conversion depends upon various factors, but from five seconds to 48 hours is possible.

In another embodiment, the duration of the sintering step ranges from one minute to 90 minutes. After sintering, the shaped abrasive particle 14 can have a Vickers hardness of 10 GPa (gigaPascals), 16 GPa, 18 GPa, 20 GPa, or greater.

Additional operations can be used to modify the described process, such as, for example, rapidly heating the material from the calcining temperature to the sintering temperature, and centrifuging the precursor dispersion to remove sludge and/or waste. Moreover, the process can be modified by combining two or more of the process steps if desired.

To form soft incomplete polygonal shaped abrasive particles the polymerizable mixtures described herein can be deposited in a cavity. The cavity can have a shape corresponding to the negative impression of the desired incomplete polygonal shaped abrasive particles. After the cavity is filled to the desired degree, the polymerizable mixture is cured therein. Curing can occur at room temperature (e.g., about 25° C.) or at any temperature above room temperature. Curing can also be accomplished by exposing the polymerizable mixture to a source of electromagnetic radiation or ultraviolet radiation.

Incomplete polygonal shaped abrasive particles can be independently sized according to an abrasives industry recognized specified nominal grade. Abrasive industry recognized grading standards include those promulgated by ANSI (American National Standards Institute), FEPA (Federation of European Producers of Abrasives), and JIS (Japanese Industrial Standard). ANSI grade designations (i.e., specified nominal grades) include, for example: ANSI 4, ANSI 6, ANSI 8, ANSI 16, ANSI 24, ANSI 36, ANSI 46, ANSI 54, ANSI 60, ANSI 70, ANSI 80, ANSI 90, ANSI 100, ANSI 120, ANSI 150, ANSI 180, ANSI 220, ANSI 240, ANSI 280, ANSI 320, ANSI 360, ANSI 400, and ANSI 600. FEPA grade designations include F4, F5, F6, F7, F8, F10, F12, F14, F16, F18, F20, F22, F24, F30, F36, F40, F46, F54, F60, F70, F80, F90, F100, F120, F150, F180, F220, F230, F240, F280, F320, F360, F400, F500, F600, F800, F1000, F1200, F1500, and F2000. JIS grade designations include JIS1158, JIS12, JIS16, JIS24, JIS36, JIS46, JIS54, JIS60, JIS80, JIS100, JIS150, JIS180, JIS220, JIS240, JIS280, JIS320, JIS360, JIS400, JIS600, JIS800, JIS1000, JIS1500, JIS2500, JIS4000, JIS6000, JIS8000, and JIS10,000.

FIGS. 6A-6F illustrate curved shaped abrasive particles in accordance with embodiments herein. FIGS. 6A-6F illustrate curved polyhedral shaped abrasive particles made using a mold with a planar surface. However, other shapes could be possible using molds with other internal surface. Additionally, while smooth edges and are illustrated, it may be possible to create grooves or other textures on any surface of an abrasive particle that contacts the mold surface during drying or other treatment.

FIGS. 6A and 6B illustrate curved abrasive particles 610 and 610a, which differ in the presence or absence of an aperture 615 which may extend partially or completely through a thickness 618. Abrasive particles 610 and 610a are formed of a layer of abrasive particle precursor with a thickness 618 that, during drying, has been induced to partially curl into a curved shape such that a surface area of an interior side 614 is smaller than an exterior surface area of an exterior side 616. Sides 614 and 616 are substantially parallel to each other. Shaped abrasive particles can also have at least one recessed (or concave) face or facet; at least one face or facet which is shaped outwardly (or convex). Methods for making dish-shaped abrasive particles are for example described in US Patent Application Publication Nos. 2010/0151195 and 2009/0165394. Additionally, shaped abrasive particles may also have a multifaceted surface as described in U.S. Pat. No. 10,150,900, issued on Dec. 11, 2018.

Shaped abrasive particles can also have a cavity. Shaped abrasive particles may also include an aperture, such as that described in U.S. Pat. No. 8,142,532, issued on Mar. 27, 2012, herein incorporated by reference.

Particles 610 and 610a each include one or more abrasive tips 612. In some embodiments, as illustrated in FIGS. 6A-6D, abrasive tips 612 (or 622) are all within a plane.

An amount of curvature of an abrasive particle may be determined by the amount of shrinkage, and the different rate of shrinkage, of the interior surface 614 with respect to the exterior layer 616. The degree of the curvature of an abrasive particle can also be determined by the thickness of precursor particles. For example, if a precursor particle has an uneven thickness, the thinner section will curve more than that of the thicker section due to less resistance from the particle body. This also allows to design abrasive particle with desired curvature structures.

FIGS. 6C and 6D illustrate curved abrasive particles 620 and 620a, which differ in the presence of an aperture, 625 which may extend partway or completely through thickness 628. Particles 620 and 620a include a plurality of abrading tips 622. Particles 620 and 620a also include an interior surface 624 and an exterior surface 626. Exterior surface 626 has a larger surface area than surface 624, which may be caused by differential shrinkage rates of surfaces 624, 626 during drying.

FIGS. 6E and 6F illustrate curved abrasive particles 630 and 630a, which differ in the presence of an aperture 635, which may extend partway or completely through thickness 638. Curved abrasive particles 630 and 630a each have four abrading tips 632, two (632a) that are substantially planar with aperture 635, and two that are present on curved areas of particles 630, 630a. Particles 630 and 630a has a thickness 638 that is substantially consistent along its area. An internal surface 634 has an area that is smaller than external surface 636, which is caused by a variation in shrinkage rates between surfaces 634, 636 during drying.

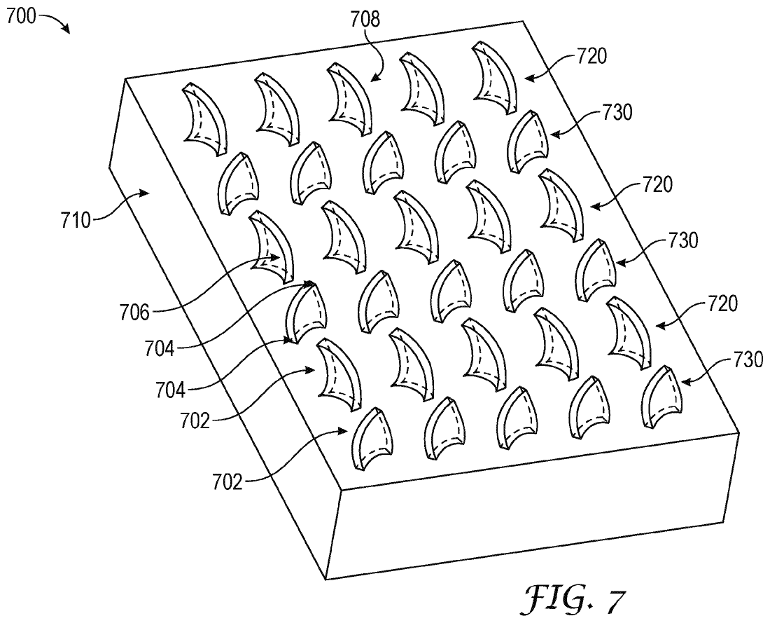

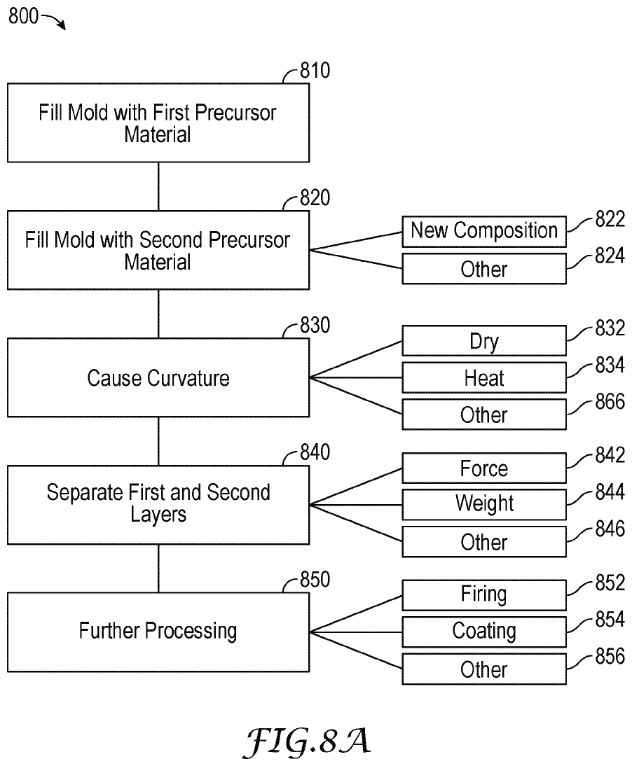

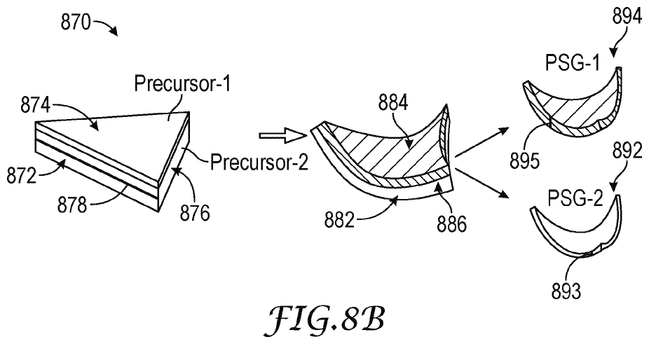

FIG. 7 illustrates curved polyhedral shaped abrasive particles precisely placed on a surface in an embodiment herein. An abrasive article 700 may include a substrate 710 with a plurality of curved abrasive particles 702 positioned thereon. Curved abrasive particles 720 each have a plurality of abrasive tips 704, each of which are oriented toward an interior surface 706 of the curved abrasive particles 702. Interior surface 706 may be substantially parallel to external surface 708 for each curved abrasive particle 702.

As illustrated in FIG. 7, abrasive particles may be precisely placed in a first orientation 720 or a second orientation 730. However, other orientations are also possible. In some embodiments, an abrasive article includes abrasive particles all oriented in a single orientation. In another embodiment, an abrasive particle may include abrasive particles in a variety of orientations. However, as described herein, abrasive particles may be magnetically coated, or otherwise configured to be aligned in precise positions on substrate 710.

The mechanism for forming convex/concave face is that when more mold release agent is present or an excess of mold release agent is present on the surfaces of the tooling in contact with the sol-gel, the precursor shaped abrasive particles tend to release from the bottom surface of the mold during drying thereby forming convex/concave faces on the dish-shaped abrasive particles.

The mechanism for forming curved PSG disclosed differs from than that of the mechanisms described in prior art, for example U.S. Pat. No. 8,142,891, issued on Mar. 27, 2012, in that the articles described herein are formed by controlling the gradient volume shrinkage of the gel particle during drying.

FIGS. 8A and 8B illustrate methods of making a curved polyhedral shaped abrasive particle in embodiments herein. Method 800 allows for making curved precision shaped abrasive particles with well-controlled curvature. In one embodiment, we show a process allows for making two different PSG particles through one path. The methods described herein may allow for thinner abrasive particles than would otherwise be easily made in a mold.

In block 810, a mold cavity is filled with a first precursor material. The precursor material may be dispensed into the mold such that it covers a bottom surface of the mold, but does not completely fill the mold.

In block 820, the mold cavity is filled with a second precursor material. The second precursor material may have the same composition as the first layer, or may have a different composition 822 as the first material. For example, the first material may be alpha alumina while the second material is zirconia alumina. Other compositions, doped compositions, or mixtures are expressly contemplated. The second precursor material may also be another material not intended for abrasive usage 824, such as a polymer or other material that facilitates curvature during drying.

In some embodiments, the second precursor material is selected such that minimal mixing will occur at an interface between the two layers, such that the two layers can be separated, in block 840, for example. However, in some embodiments, some mixing, fusing or other bonding occurs such that the layers do not easily separate.

In block 830, curvature is induced in the abrasive particle. Curvature may be caused by drying the particle, as indicated in block 832, in such a way that one of the first and second layers dries faster than the other, causing curling at the edges. Heating may also be applied, as indicated in block 834. Other methods are also contemplated, as indicated in block 836.

In block 840, in some embodiments, the first and second layers are separated. In some embodiments, only one layer will be used for forming abrasive articles, so when the abrasive particle precursors are removed from the mold cavities, they need to be separated into the portions that will be incorporated into abrasive articles, and the portions that will be discarded. Physical separation of the first and second layers from each other may occur easily during removal from the mold, or may require some force 842. For example, the mold may be subjected to vibrations to induce separation of the layers from each other. It may also help separating the portions that will be kept from those to be discarded. The layers may also be separated by weight 844, or using another mechanism 846.

In block 850, the curved abrasive particles are further processed. Processing may include preparing the curved abrasive particles for incorporation into abrasive articles. For example, the curved abrasive particles may be further dried or fired, as indicated in block 852. The abrasive particles may also undergo a coating step, as indicated in block 854. For example, coating the abrasive particles with a magnetically responsive coating layer may make precise alignment on a backing or other substrate possible. Other processing, as indicated in block 856, may also be done.

FIG. 8B shows a schematic 870 that illustrates the formation of a curved abrasive particle 892 and a discarded layer 894. However, while a top layer 894 is illustrated in FIG. 8B as the discarded layer, in other embodiments it may be abrasive particle 892 that is discarded. For example, a sacrificial precursor layer may be easier to remove from a mold and, therefore, used as a mold contacting layer.

A mold is first filled with a first layer of precursor material 872, and then a second layer of precursor material 874. An interface 876 may be present between the first and second layers 872, 874.

A drying step causes the two layers to curl, resulting from a bottom layer 882 drying at a different rate than top layer 884. The convex/concave formation of layers 882, 884 is due to the gradient volume shrinking during gel drying. For example, if the surface layer of the gel dries faster than that of the inside of portion of the gel particle and its volume shrinks more than that of the inside portion of the gel particles, leads to the formation of convex/concave surfaces. The gradient volume shrinking can be achieved by gradient solid, gradient temperature, or by using gel/slurry precursor mixtures with different dry speed or volume shrinkage. The top layer could be a temporary sacrifice layer or the same composition as the inside layer of the gel. In one embodiment, a temporary sacrifice layer 884 is used. In another embodiment, a precursor slurry with two different solids content generates gradient drying/shrinking to form convex/concave structures.

When drying is complete, the two layers separate at interface 886 to form particle portions 892 and 894. Particle portions 894 and 892 may both comprise ceramic material or, in other embodiments, a sacrificial portion may comprise a polymer or other softer material. A suitable temporary sacrifice layer is a material that is a combustible or soluble material can be removed after the particle was made. A common way to eliminate the temporary sacrifice layer is by burning out the layer during pre-firing, firing or sintering. Typical temporary sacrifice layer are polymer layers such as starch, poly vinyl alcohol, celluloses, and gelatin. In one embodiment, a poly vinyl alcohol (PVA) solution (5-10% by weight) was used as typical temporary sacrifice layer.

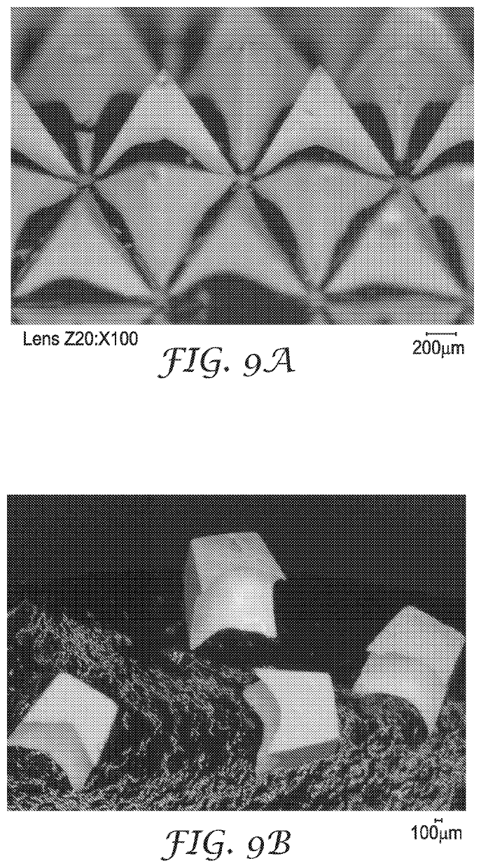

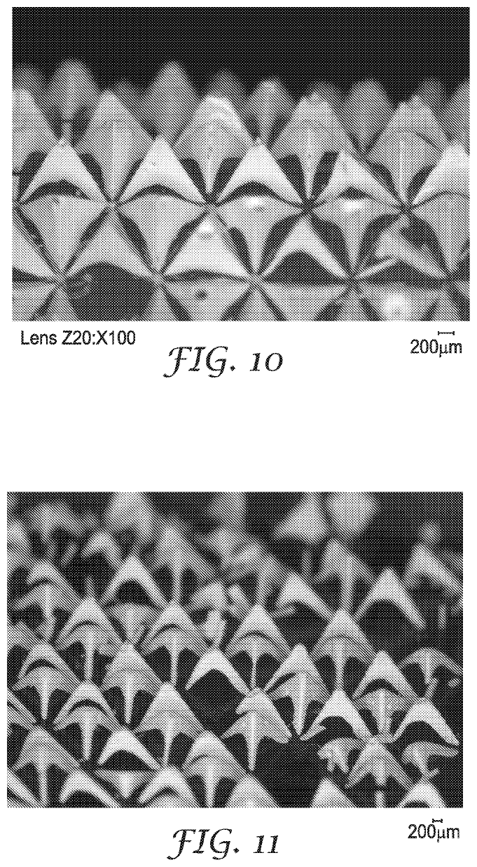

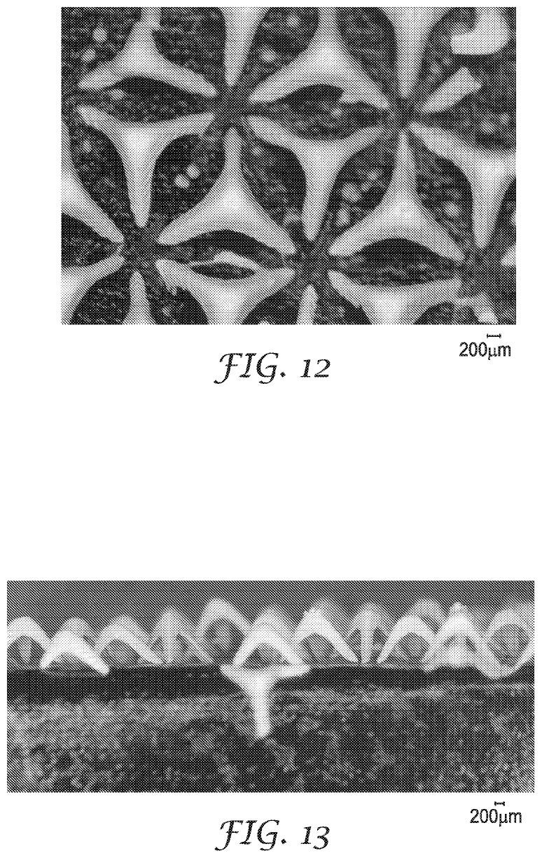

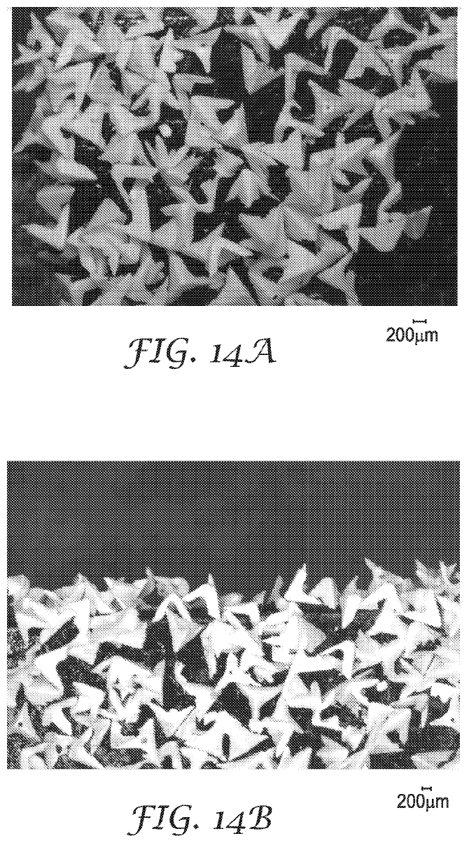

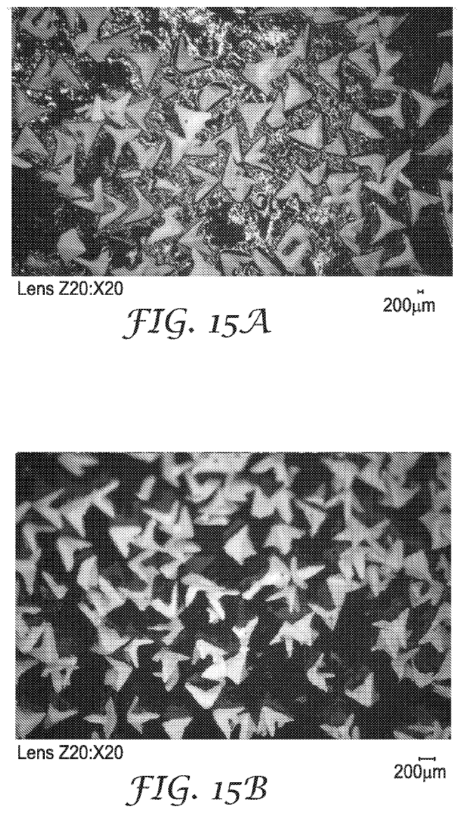

FIGS. 9-14 illustrate examples of incomplete tetrahedral shaped particles in accordance with embodiments of the present invention. FIGS. 9A and 9B illustrate example incomplete shaped abrasive particles. For example, FIG. 9A illustrates incomplete tetrahedral particles, while FIG. 9B illustrates incomplete cubic shaped particles. FIG. 10 shows example incomplete tetrahedral shaped abrasive particles. FIGS. 11-13 show example incomplete tetrahedral shaped abrasive particles with grooves present on their faces. FIGS. 14A and 14B shows example sintered incomplete tetrahedral shaped abrasive particles.

The shaped abrasive particles are typically selected to have a length in a range of from 0.001 mm to 26 mm, more typically 0.1 mm to 10 mm, and more typically 0.5 mm to 5 mm, although other lengths may also be used.

According to various embodiments of the present disclosure, an abrasive article is disclosed. The abrasive article can be chosen from many different abrasive articles such as an abrasive belt, an abrasive sheet or an abrasive disc.

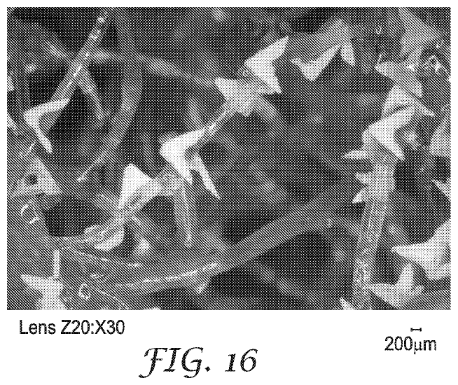

FIGS. 15-17 illustrate example abrasive articles incorporating incomplete tetrahedral shaped particles in accordance with embodiments of the present invention. FIGS. 15A and 15B show example fiber discs incorporating incomplete tetrahedral shaped abrasive particles. As illustrated in FIGS. 15A and 15B, orientation of incomplete tetrahedral shaped abrasive particles may not be as necessary as it is for other shaped abrasive particles since incomplete tetrahedral shaped abrasive particles generally have more abrasive edges available.

FIG. 15C is a sectional view of a coated abrasive article 1200, for example the coated fiber discs illustrated in FIGS. 15A and 15B. The coated abrasive article 1200 includes a backing 1210 defining a substantially planar major surface along an x-y direction. Backing 1210 has a first layer of binder, which may be referred to as a make coat 1220, applied over a first surface of the backing 1210. Attached or partially embedded in the make coat 14 are a plurality of incomplete polygonal abrasive particles 1250. A second layer of binder, hereinafter referred to as a size coat 18, is dispersed over the incomplete polygonal abrasive particles 1250. The coated abrasive article 1210 can be formed to be any suitable abrasive article.

Backing 1210 can be flexible or rigid. Examples of suitable materials for forming a flexible backing include a polymeric film, a metal foil, a woven fabric, a knitted fabric, paper, vulcanized fiber, a staple fiber, a continuous fiber, a nonwoven, a foam, a screen, a laminate, and combinations thereof. Backing 1210 can be shaped to allow coated abrasive article 1200 to be in the form of sheets, discs, belts, pads, or rolls. In some embodiments, backing 1210 can be sufficiently flexible to allow coated abrasive article 1200 to be formed into a loop to make an abrasive belt that can be run on suitable grinding equipment.

Make coat 1220 secures incomplete shaped abrasive particles 1250 to backing 1210, and a size coat 1230 can help to reinforce particles 1250. Make coat 1210 and/or the size coat 1230 can include a resinous adhesive. The resinous adhesive can include one or more resins chosen from a phenolic resin, an epoxy resin, a urea-formaldehyde resin, an acrylate resin, an aminoplast resin, a melamine resin, an acrylated epoxy resin, a urethane resin, and mixtures thereof.

Various methods can be used to make any of the abrasive articles of the present disclosure. For example, the coated abrasive article 1200, can be formed by applying make coat 1220 on backing 1210. Make coat 1220 can be applied by any suitable technique such as roll coating. Incomplete polygonal shaped abrasive particles 1250 can then be deposited on make coat 1220. Alternatively, abrasive particles 1250 and make coat 1220 formulation can be mixed to form a slurry, which is then applied to backing 1210. If coated abrasive article 1200 includes incomplete shaped abrasive particles, crushed abrasive particles, and secondary shaped abrasive particles, those particles can be applied as discrete groups sorted by particle type, or together. Once incomplete abrasive particles 1250 are deposited on backing 1210, make coat 1220 is cured at an elevated temperature or at room temperature for a set amount of time and incomplete polygonal shaped abrasive particles 1250 adhere to backing 1210. A size coat 1230 can then be optionally applied over the coated abrasive article 1200.

In coated abrasive article 1200, incomplete polygonal shaped abrasive particles 1250 can range from about 1 wt % to about 90 wt % of the abrasive layer, or about 10 wt % to about 50 wt % of the abrasive article, or can be less than, equal to, or greater than about 1 wt %, 5, 10, 15, 20, 25, 30, 35, 40, 45, 50, 55, 60, 65, 70, 75, 80, 85, or 90 wt %.

Abrasive particles 1250 can be deposited on backing 1210 through any suitable technique. For example, abrasive particles 1250 can be deposited through a drop-coating technique or an electrostatic-coating technique onto backing 1210. In drop-coating, abrasive particles 1250 are free-form deposited on make coat 1220. In an example of an electrostatic-coating technique, an electrostatically charged vibratory feeder can be used to propel abrasive particles 1250 off of a feeding surface towards a conductive member located behind backing 1210. In some embodiments, the feeding surface can be substantially horizontal and the coated backing can be traveling substantially vertically. Abrasive particles 1250 pick up a charge from the feeder and are drawn towards the backing by the conductive member.

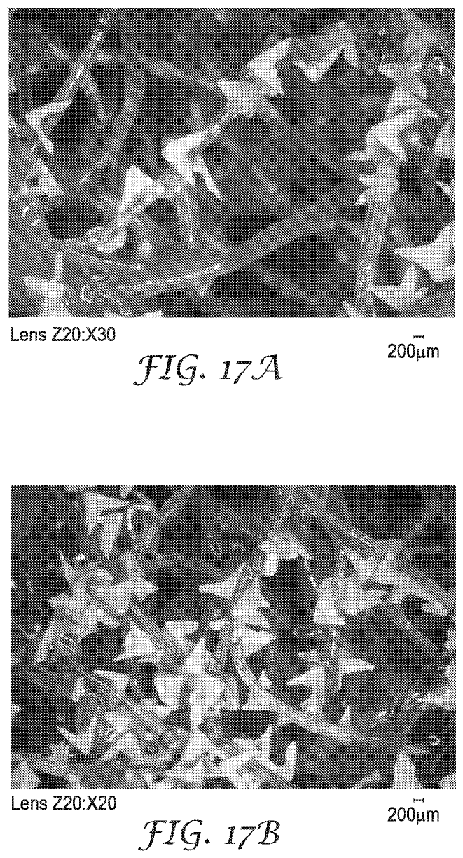

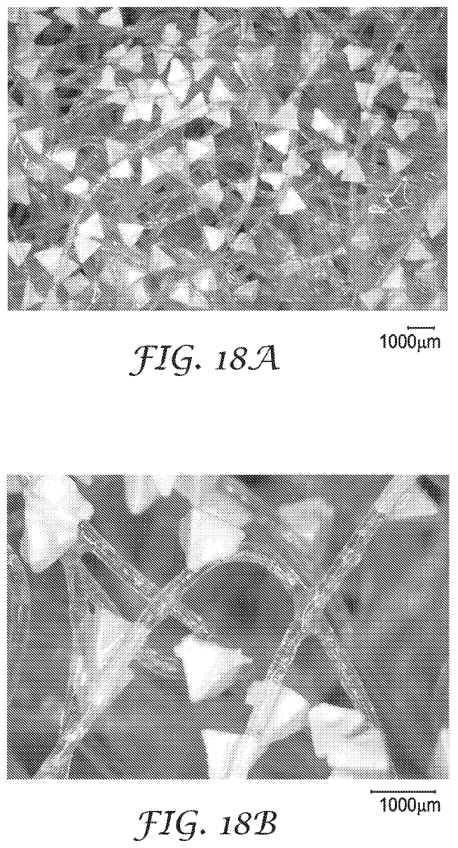

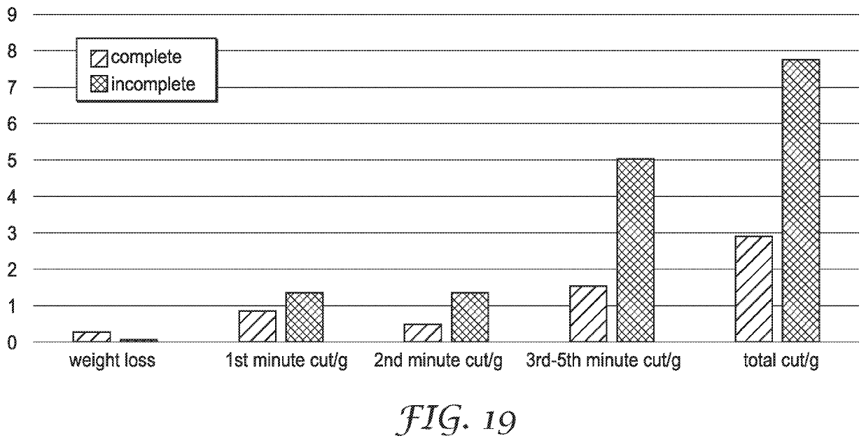

FIGS. 16, 17A and 17B are images of nonwoven abrasive articles incorporating incomplete tetrahedral shaped abrasive particles. FIGS. 18A-18B illustrates a comparative abrasive article comprising tetrahedral shaped particles. The incomplete tetrahedral shaped abrasive particles illustrated in FIGS. 16 and 17 are more closely held within the nonwoven fibers than the tetrahedral particles of FIG. 18. This may result in reduced shelling experienced during use. Additionally, abrasive articles incorporating incomplete tetrahedral shaped particles experience better performance than those incorporating comparative tetrahedral shaped particles, as illustrated in FIG. 19.

FIG. 19 illustrates example performance data for an embodiment of the present invention and a comparative sample. As illustrated in the graph, the samples shown in FIG. 17 were compared against those shown in FIG. 18. The incomplete tetrahedral shaped particles experienced reduced weight loss and higher cut performance in the first five minutes of use. This represents significantly better performance than that obtained using complete tetrahedral shaped abrasive particles.

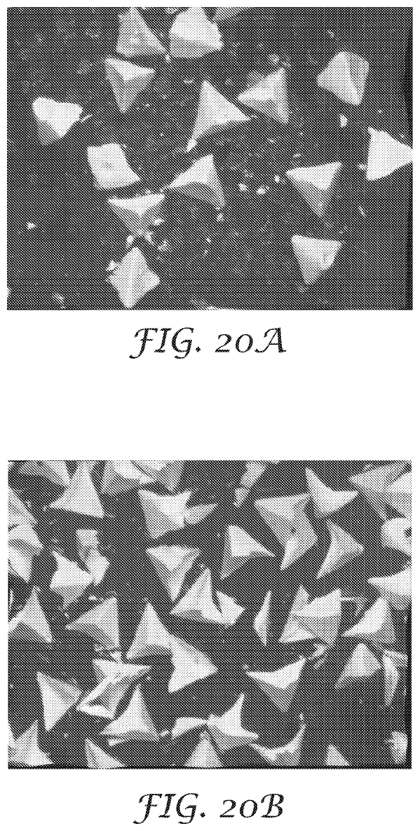

FIGS. 20A and 20B illustrate comparative edge sharpness of embodiments of the present invention and a comparative sample.

While abrasive discs and nonwoven abrasive articles are expressly shown, incomplete polygonal shaped abrasive particles can also be incorporated in an abrasive belt for continuous abrading operations. In other embodiments, however, the abrasive article can be an abrasive disc that is adapted for rotational movement. In some embodiments, Incomplete polygonal shaped abrasive particles can be included in a random orbital sander or vibratory sander.

Incomplete polygonal shaped abrasive particles can account for 100 wt % of the abrasive particles in any abrasive article. Alternatively, incomplete polygonal shaped abrasive particles can be part of a blend of abrasive particles distributed on backing 204. If present as part of a blend, incomplete polygonal shaped abrasive particles may be in a range of from about 5 wt % to about 95 wt % of the blend, about 10 wt % to about 80 wt %, about 30 wt % to about 50 wt %, or less than, equal to, or greater than about, 5 wt %, 10, 15, 20, 25, 30, 35, 40, 45, 50, 55, 60, 65, 70, 75, 80, 85, 90, or about 95 wt %, of the blend. In the blend, the balance of the abrasive particles may include conventional crushed abrasive particles. Crushed abrasive particles are generally formed through a mechanical crushing operation and have no replicated shape. The balance of the abrasive particles can also include other shaped abrasive particles, that may for example, include an equilateral triangular shape (e.g., a flat triangular shaped abrasive particle or a tetrahedral shaped abrasive particle in which each major face of the tetrahedron is an equilateral triangle).

Any abrasive article can include a make coat to adhere incomplete polygonal shaped abrasive particles, or a blend of incomplete polygonal shaped abrasive particles and crushed abrasive particles to a backing. The abrasive article may further include a size coat adhering the shaped abrasive particles to the make coat. The make coat, size coat, or both can include any suitable resin such as a phenolic resin, an epoxy resin, a urea-formaldehyde resin, an acrylate resin, an aminoplast resin, a melamine resin, an acrylated epoxy resin, a urethane resin, or mixtures thereof. Additionally, the make coat, size coat, or both can include a filler, a grinding aid, a wetting agent, a surfactant, a dye, a pigment, a coupling agent, an adhesion promoter, or a mixture thereof. Examples of fillers may include calcium carbonate, silica, talc, clay, calcium metasilicate, dolomite, aluminum sulfate, or a mixture thereof.

The distribution tool including incomplete polygonal shaped abrasive particles can be left in contact with the backing for any suitable amount of time as Incomplete polygonal shaped abrasive particles adhere to the make coat. After sufficient time has passed for good adhesion between Incomplete polygonal shaped abrasive particles and the make coat, the production tool is removed and a size coat is optionally disposed over Incomplete polygonal shaped abrasive particles.

The shaped abrasive particles described herein can also be used to form aggregate particles. The aggregate particles may include shaped abrasive particles in a vitreous bond matrix as described, for example, in U.S. PAP 2018/081246, published on May 3, 2018. The aggregate particles may also include shaped abrasive particles in a silicate binder, as described in WO 2019/167022, published on Sep. 6, 2019.

Once the magnetizable particles are coated on to the curable binder precursor it is at least partially cured at a first curing station (not shown), so as to firmly retain the magnetizable particles in position. In some embodiments, additional magnetizable and/or non-magnetizable particles (e.g., filler abrasive particle and/or grinding aid particles) can be applied to the make layer precursor prior to curing.

In the case of a coated abrasive article, the curable binder precursor includes a make layer precursor, and the magnetizable particles include magnetizable abrasive particles. A size layer precursor may be applied over the at least partially cured make layer precursor and the magnetizable abrasive particles, although this is not a requirement. If present, the size layer precursor is then at least partially cured at a second curing station, optionally with further curing of the at least partially cured make layer precursor. In some embodiments, a supersize layer is disposed on the at least partially cured size layer precursor.

According to various embodiments, a method of using an abrasive article such as an abrasive belt or an abrasive disc includes contacting the incomplete polygonal shaped abrasive particles with a workpiece or substrate. The workpiece or substrate can include many different materials such as steel, steel alloy, aluminum, plastic, wood, or a combination thereof. Upon contact, one of the abrasive article and the workpiece is moved relative to one another in direction of use and a portion of the workpiece is removed.

The present invention relates to a method for abrading a workpiece, the method comprising frictionally contacting at least a portion of an abrasive article according to the invention with a surface of a workplace; and moving at least one of the workpiece or the abrasive article (while in contact) to abrade at least a portion of the surface of the workpiece.

During use, the abrasive article can be used dry or wet. During wet grinding, the abrasive article is typically used in conjunction with a grinding fluid which may for example contain water or commercially available lubricants (also referred to as coolants). During wet grinding lubricants are commonly used to cool the workpiece and the abrasive article, lubricate the interface, remove swarf (chips), and clean the abrasive article. The lubricant is typically applied directly to the grinding area to ensure that the fluid is not carried away by the abrasive article. The type of lubrication used depends on the workpiece material and can be selected as is known in the art. One advantage of using incomplete polygonal abrasive particles is their ability to incorporate and retain lubricant within the empty spaces within their structure.

Common lubricants can be classified based on their ability to mix with water. A first class suitable for use in the present invention includes oils, such as mineral oils (typically petroleum based oils) and plant oils. A second class suitably for use in the present invention includes emulsions of lubricants (for example mineral oil based lubricants; plant oil based lubricants and semi-synthetic lubricants) and solutions of lubricants (typically semi-synthetic and synthetic lubricants) with, water.

An abrasive particle is presented. The particle includes an incomplete polygonal shape having a first arm and a second arm. The incomplete polygonal shape is defined in part by a mold with a polygonal shape. The first arm is formed by a first edge of the polygonal mold and the second arm is formed by a second edge of the polygonal mold.

The abrasive particle may be implemented such that the incomplete polygonal shape comprises a vertex.

The abrasive particle may be implemented such that it includes a concave surface.

The abrasive particle may be implemented such that the first arm and the second arm are substantially the same size.

The abrasive particle may be implemented such that the first arm is substantially shorter than the second arm.

The abrasive particle may be implemented such that the incomplete polygonal shape is an incomplete tetrahedron, an incomplete cube, or an incomplete pentahedron.

The abrasive particle may be implemented such that the incomplete polygonal shape comprises at least one surface with an arc-shaped edge.

The abrasive particle may be implemented such that the abrasive particle comprises a ceramic or polymeric material.

The abrasive particle may be implemented such that the abrasive particle comprises alpha alumina or sol-gel derived alpha alumina.

The abrasive particle may be implemented such that the abrasive particle comprises fused aluminum oxide, a heat-treated aluminum oxide, a ceramic aluminum oxide, a sintered aluminum oxide, a silicon carbide material, a titanium diboride, a boron carbide, a tungsten carbide, a titanium carbide, a diamond, a cubic boron nitride, a garnet, a fused alumina-zirconia, a cerium oxide, a zirconium oxide, or a titanium oxide.

The abrasive particle may be implemented such that the abrasive particle comprises a polymerizable material with a resin.

The abrasive particle may be implemented such that the resin is a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, or a drying oil.

The abrasive particle may be implemented such that the abrasive particle comprises plasticizer, an acid catalyst, a cross-linker, a surfactant, a mild-abrasive, a pigment, a catalyst or an antibacterial agent.

The abrasive particle may be implemented such that the surface of the first and second arms comprise grooves.

A abrasive article comprising a plurality of particles such as those described herein. Where the article includes a backing. The plurality of particles are attached to the backing. The abrasive article is configured to abrade a surface.

The abrasive article may be implemented such that the abrasive article is a coated abrasive article that further includes a make coat layer on the backing, wherein the plurality of particles are embedded within the make coat.

The abrasive article may be implemented such that it includes a size coat.

The abrasive article may be implemented such that it includes a top coat.

The abrasive article may be implemented such that the plurality of particles are attached to the backing in a random orientation.

The abrasive article may be implemented such that the backing includes nonwoven fibers, and wherein the plurality of particles are embedded within the nonwoven fibers.

The abrasive article may be implemented such that it includes a binder.

The abrasive article may be implemented such that it includes a grinding aid.

The abrasive article may be implemented such that it includes a lubricant.

The abrasive article may be implemented such that the abrasive article comprises a disc.

The abrasive article may be implemented such that the abrasive article comprises a belt.

A method of manufacturing the incomplete polygonal shaped abrasive particles described herein is also presented. The method includes filling the polygonal mold with a precursor slurry. The method also includes drying the precursor slurry such that a precursor incomplete polygonal shaped abrasive particle is formed.

The method may be implemented such that it includes calcining the precursor incomplete polygonal shaped abrasive particle.

The method may be implemented such that it also includes sintering the calcined precursor incomplete polygonal shaped abrasive particle.

The method may be implemented such that filling the polygonal mold comprises partially fulling the polygonal mold.

The method may be implemented such that filling the polygonal mold comprises fully filling the polygonal mold.

The method may be implemented such that filling the polygonal mold comprises filling a portion of the polygonal mold such that a portion of the polygonal mold remains empty, and wherein the empty portion comprises an internal edge of the polygonal mold.

An abrasive particle precursor is presented. The precursor includes a first layer comprising a first precursor composition. The precursor also includes a second layer comprising a second precursor composition. The first and second layers are separable along an interface between the first and second layer. Each of the first and second layers have curvature, and wherein the first and second layers are parallel to each other.

The abrasive particle precursor may be implemented such that the first precursor composition comprises: aluminum oxide, alpha aluminum oxide, brown aluminum oxide; blue aluminum oxide; silicon carbide, green silicon carbide; titanium diboride; boron carbide; tungsten carbide; garnet; titanium carbide; diamond; cubic boron nitride; garnet; alumina zirconia, fused alumina zirconia; iron oxide; chromia; zirconia; titania; tin oxide; quartz; feldspar; flint; emery; or a sol-gel.

The abrasive particle precursor may be implemented such that the second precursor composition comprises: aluminum oxide, alpha aluminum oxide, brown aluminum oxide; blue aluminum oxide; silicon carbide, green silicon carbide; titanium diboride; boron carbide; tungsten carbide; garnet; titanium carbide; diamond; cubic boron nitride; garnet; alumina zirconia, fused alumina zirconia; iron oxide; chromia; zirconia; titania; tin oxide; quartz; feldspar; flint; emery; or a sol-gel.

The abrasive particle precursor may be implemented such that the first or second layers is a sacrificial layer not suitable for abrasive operations.

The abrasive particle precursor may be implemented such that the sacrificial layer comprises: a polymer.

The abrasive particle precursor may be implemented such that the sacrificial layer comprises a softer material than a non-sacrificial layer.

The abrasive particle precursor may be implemented such that the first layer comprises a plurality of corners, and wherein curvature causes the plurality of corners to curve in the same direction, such that all of the plurality of corners face the same direction.

The abrasive particle precursor may be implemented such that the plurality of corners are coplanar to each other.

The abrasive particle precursor may be implemented such that some of the corners experience greater curvature than others, such that the plurality of corners are not coplanar to each other.

A method for forming a curved abrasive particle is presented. The method includes partially filling a mold cavity with a first composition layer. The method may also include partially filling a mold cavity with a second composition layer. The method may also include drying the first and second composition to form an abrasive particle precursor comprising a first precursor layer and a second precursor layer, wherein drying causes the abrasive particle precursor to develop curvature. The first or second composition is an abrasive particle precursor material.

The method may be implemented such that drying causes the first composition to peel away at the corners of the mold.

The method may be implemented such that drying causes the first composition to peel away in the interior of the mold.

The method may be implemented such that prior to drying, the first composition and second compositions layers are planar, and wherein, after drying, each of the first and second composition layers has convex curvature.

The method may be implemented such that both first and second compositions comprise abrasive particle precursor material, and wherein each of the first and second compositions are selected from the group consisting of: aluminum oxide, alpha aluminum oxide, brown aluminum oxide; blue aluminum oxide; silicon carbide, green silicon carbide; titanium diboride; boron carbide; tungsten carbide; garnet; titanium carbide; diamond; cubic boron nitride; garnet; alumina zirconia, fused alumina zirconia; iron oxide; chromia; zirconia; titania; tin oxide; quartz; feldspar; flint; emery; and a sol-gel.

The method may be implemented such that it includes separating the first and second precursor along an interface between the first and second precursor layers to form a first abrasive particle precursor and a second abrasive particle precursor.

The method may be implemented such that the first abrasive particle precursor comprises a sacrificial material.

The method may be implemented such that the second abrasive particle precursor includes a sacrificial material.

The method may be implemented such that the abrasive particle precursor has an internal surface and an external surface and wherein the internal surface is substantially parallel to the external surface at a point along the curvature.

The method may be implemented such that the curvature is substantially even such that a plurality of vertices of the abrasive particle precursor are planar to each other.

The method may be implemented such that the curvature is uneven, such that a plurality of vertices are nonplanar.

The method may be implemented such that the abrasive particle precursor comprises abrading tips formed from a plurality of corners of the mold cavity.

The method may be implemented such that the mold cavity comprises four corners.

The method may be implemented such that it also includes processing one of the first and second abrasive particle precursors to form a curved abrasive particle.

The method may be implemented such that processing comprises firing the abrasive particle precursor.

The method may be implemented such that processing comprises applying a magnetically responsive coating to the abrasive particle.

The method may be implemented such that processing comprises forming an abrasive article using the curved abrasive particle, wherein the abrasive article is a coated abrasive article, a nonwoven abrasive article or a bonded abrasive article.

The method may be implemented such that processing destroys one of the first and second abrasive particle precursors.

The method may be implemented such that the sacrificial material comprises a polymer.

### EXAMPLES

Various embodiments of the present disclosure can be better understood by reference to the following Examples which are offered by way of illustration. The present disclosure is not limited to the Examples given herein.

Unless otherwise noted, all parts, percentages, ratios, etc. in the Examples and the rest of the specification are by weight. Unless stated otherwise, all other reagents were obtained, or are available from fine chemical vendors such as Sigma-Aldrich Company, St. Louis, Mo., or may be synthesized by known methods.

Unit Abbreviations used in the Examples:

° C.: degree Celsius

cm: centimeter

IN: inch

g: gram

g/m2: grams per square meter

rpm: revolutions per minute

mm: millimeter

wt. %: weight percent.

Materials used in the Examples are described in Table 1:

TABLE 1

| ABBREVIATION | DESCRIPTION |
|---|---|
| SAP | SAP are precision shaped abrasive particles. Examples of SAP were |
| | described in U.S. Pat. No. 8,142,531 (Adefris et al.), and U.S. patent |
| | application No. 2015/0267097 A1 (Rosenflanz et al.). The shaped |
| | abrasive particles were prepared by molding the ceramic precursor |
| | pre-Mix in equilateral triangle-shaped polypropylene mold cavities. |
| | After drying and firing, the resulting shaped abrasive particles were |
| | about 0.18 mm (side length) × 0.04 mm thick, with a draft angle |
| | approximately 98 degrees. |
| CSAP | Complete precision shaped abrasive particles (CSAP) used as |
| | comparative examples in this application. CSAP was made |
| | according to the method described in applications |
| | PCT/IB2018/053300 and PCT/US2018/037023. |
| ISAP | Incomplete shaped abrasive particles (ISAP) disclosed in this application. |
| Mold | The making process involves providing a mold having at least one |
| | precision shaped mold cavity, and preferably a plurality of precision |
| | shaped mold cavities. The mold can have a generally planar bottom |
| | surface and a plurality of mold cavities. The plurality of precision |
| | shaped mold cavities can be formed in a production tool. The |
| | production tool can be a belt, a sheet, a continuous web, a coating |
| | roll such as a rotogravure roll, a sleeve mounted on a coating roll, or |
| | die. The cavity has a specified three-dimensional shape. In one |
| | embodiment, the shape of a cavity can be described as being a |
| | triangle. Alternatively, other cavity shapes can be used, such as, |
| | rectangles, squares, hexagons, stars, or combinations thereof. The |
| | production tool described in WO application WO/2018/207145 |
| | were used to make tetrahedral shaped abrasive particles. |
| RA | Mold releasing agent. In many embodiments, a mold release agent |
| | may include in the precursor pre-mix or coat onto the mold surface |
| | as disclosed in W02014/070468A1 (Rosenflanz, et al.), to aid in |
| | removing the shaped abrasive precursor particles from the substrate, |
| | if desired. Typical mold release agents include oils such as peanut |
| | oil or mineral oil, fish oil, silicones, polytetrafluoroethylene (ptfe), |
| | zinc stearate, and graphite. In general, a mold release agent such as |
| | peanut oil, in a liquid, such as water or alcohol, is applied to the |
| | surfaces of the production tooling in contact with the slurry such that |
| | between about 0.1 mg/in2 (0.6 mg/cm2) to about 3.0 mg/in2 (20 |
| | mg/cm2), or between about 0.1 mg/in2 (0.6 mg/cm2) to about 5.0 |
| | mg/in2 (30 mg/cm2) of the mold release agent is present when a |
| | mold release is desired. Unless otherwise noted, the release agent |
| | solution is 0.2% peanut oil in methanol by weight. |
| Sol-Gel Precursor | In general, Sol-Gel Precursor pre-Mix is a dispersion comprising |
| pre-Mix | water, colloid alumina source, and optionally peptizing agent (e.g., |
| | an acid such as nitric acid) as described in U.S. patent U.S. 6,287,353. |
| | An example of precursor sol-gel mixture was made using the |
| | following recipe: aluminum oxide monohydrate powder (1600 |
| | parts) having the trade designation “DISPERAEL’ (Sasol Chemicals |
| | North America LLC, Houston, Texas) was dispersed by high shear |
| | mixing a solution containing water (2400 parts) and 70% aqueous |
| | nitric acid (72 parts) for 11 minutes. The resulting Sol-gel precursor |
| | was aged for at least 1 hour before use. |
| Slurry Precursor | In general, Slurry Precursor Pre-Mix is a dispersion comprising |
| Pre-Mix | water, non-colloidal alumina powder source, and optionally |
| | stabilizing agent and temporary binder, as described in U.S. patent |
| | application No. 2015/0267097 A1. An example of precursor slurry was |
| | made using the following recipe: A polyethylene-lined ball-mill jar |
| | was charged with 100 grams (g) of deionized water, 0.5 g of |
| | ammonium citrate dispersant agent, and 400 g of aluminum oxide |
| | powder (product ID: SPA-0.5, with Alumina oxide purity of |
| | 99.995%) from Sasol North America, Inc Sasol North America |
| | Inc., Tucson, Arizona as CERALOX. About 700 grams of alumina |
| | milling media (10 mm diameter; 99.9% alumina; obtained from |
| | Union Process, Akron, Ohio) were added to the bottle, and the |
| | mixture was milled at 120 rpm for 24 hours. After milling, the |
| | milling media was removed and the slurry was degassed by placing |
| | it into a desiccator jar and applying a vacuum using mechanical |
| | pump (about 10 minutes hold under vacuum). |
| Keyence | Optical microscope, VK-5000 made by Keyence Corporation (USA) |
| SEM | Scanning Electron Microscope, JSM-7610F, JEOL Ltd. (Japan) |
| PU1 | Blocked urethane prepolymer, obtained as “ADIPRENE BL31” |
| | from Chemtura Corporation, Middlebury, Connecticut |
| CUR | Aromatic amine curative, obtained as “RAC-9907” from Royce |
| | international, East Rutherford, New Jersey |
| PMA | Propylene glycol monomethyl ether, obtained as “DOWANOL |
| | PMA” from Dow Chemical Company, Midland, Michigan |
| PR | A 25M solution of phenoxy resin in 1-methoxy-2-acetopropane, |
| | obtained as “INCHEMREZ PKHS” from InChem Corp, Rock Hill, |
| | South Carolina |
| OS | Organosilane, obtained as “XIAMETER OFS-6040 SHANE” from |
| | Dow Chemical Corporation, Midland, Michigan |
| CaCO3 | Calcium carbonate, obtained as “HUBERCARB Q325” from |
| | Huber Engineered Materials, Quincy, Illinois |
| ASIL1 | Amorphous silica, obtained as “AEROSIL R202” from Evonik |
| | Degussa Corporation USA, Parsippany, New Jersey |
| Pre-bond coating | A mix comprising 36.8 parts of PU1, 13.5 parts of CUR, 20.3 parts |
| | of PMA, 22 parts of PR, 0.8 parts of OS, 5 parts of CaCO3, and 1.5 |
| | parts of ASIL1. |
| PF1 | Phenol-formaldehyde resin having a phenol to formaldehyde molar |
| | ratio of 1:1.5-2.1, and catalyzed with 2.5 percent by weight |
| | potassium hydroxide. |
| CACO | Calcium Carbonate commercially available as Hubercarb Q325 |
| | from Hubercarb Engineered Materials, Atlanta Georgia. |
| F1 | Nylon 6,6 500 denier 76.2 mm staple fibers, obtained as “PN100” |
| | from Palmetto Synthetics, LLC, Kingstree, South Carolina |
| F2 | Nylon 6,6 1000 denier 76.2 mm staple fibers, obtained as “PNlOl” |
| | from Palmetto Synthetics, LLC, Kingstree, South Carolina |
| Make resin | Phenolic Make Resin 1 was prepared by mixing 49.2 parts by |
| | weight of PR1; 40.6 parts by weight of CACO; and 10.2 parts by |
| | weight of deionized water. |

### Example 1

### Incomplete Shaped Abrasive Particles From Slurry Precursor Pre-Mix

A piece of production tool (9×11 inches by size, 64.3 g by weight) was pre-treated with a RA solution with a brush and then dried at 50 degrees Celsius for 10 minutes before use. The Slurry Precursor Pre-mix was spread into the mold cavities with putty knife to completely fill the shaped cavities of the tool and then the wet slurry coating layer was squeezed with a High-Density Polyester Knit Paint Roller Cover (9×1.25 inch, Model #RC 147, LINZER PRODUCTS CORP., West Babylon, N.Y., US) to reduce the precursor pre-mix add-on on the production tool to 29.4 g/(9×11 inches). The tool together with the precursor premix were dried at 50 degrees Celsius for 5 minutes. The dried precursor particles were released from the tool with the aid of sonication vibration, resulting in the dried incomplete shaped precursor particles. The dried precursor particles were converted to abrasive mineral particles according to the procedures described in U.S. Pat. Appl. No. 2015/0267097 A1.

### Comparative Example 1

### Complete Tetrahedral Shaped Abrasive Particles Made With Slurry Precursor Pre-Mix

A complete tetrahedral shaped abrasive particle was formed using the same procedure as Example-1, with the exception that the slurry pre-mix add-on on the production tool was 48.5 g/(9×11inches).

### Example 2

### Incomplete Tetrahedral Shaped Abrasive Particles Made With Sol-Gel Precursor Pre-Mix

An incomplete tetrahedral shaped abrasive particle was formed using the same procedure as Example-1, with the exception that the Sol-Gel Precursor pre-mix. The dried precursor particles were converted to abrasive mineral particles according to the procedures described in U.S. Pat. No. 6,287,353.

### Comparative Example 2

### Complete Tetrahedral Shaped Abrasive Particles Made With Sol-Gel Precursor Pre-Mix

An incomplete tetrahedral shaped abrasive particle was formed using the same procedure as Example-1, with the exception that the Sol-Gel Precursor pre-mix was used. The dried precursor particles were converted to abrasive mineral particles according to the procedures described in U.S. Pat. No. 6,287,353.

### Measuring the Bulk Density of Dried Precursor Particles and Fired Abrasive Particles.

Bulk density of the dried precursor particles and fired abrasive particles were measured according to the procedure described in ANSI B74.4-1992 Procedure for Bulk Density of Abrasive Grains.

### Measuring the True Density of Fired Abrasive Particles

The True Density was measured using a Micromeritics ACCUPYC 1330 HELIUM PYCNOMETER (Micromeritics Instrument Corporation, Norcross, Ga.).

Table-2 summarizes the difference between EXAMPLE-1 and COMPARATIVE EXAMPLE-1, and EXAMPLE-2 and COMPARATIVE EXAMPLE-2. In comparison with the complete tetrahedral shaped abrasive particles, the incomplete volume of the abrasive grain made in EXAMPLE-1 is 27.36% and the incomplete volume of the abrasive grain made in EXAMPLE-2 is 55.78%, respectively.

TABLE 2

| | | | | Dried | Dried | Fired | Fired | |
|---|---|---|---|---|---|---|---|---|
| | tool | | | precursor | precursor | abrasive | abrasive | Incomplete |
| | size | tool | Premix | particles | particles | particles | particles | volume |
| | (inch × | weight | add-on | weight | bulk density | bulk density | true density | fraction |
| sample | inch) | (gram) | (gram) | (gram) | (g/cm3) | (g/cm3) | (g/cm3) | (%) |
| Example-1 | 9 × 11 | 64.3 | 29.4 | 24.5 | 1.0908 | 1.3245 | 3.7886 | 27.36 |
| Comparative | 9 × 11 | 64.8 | 48.5 | 40.1 | 1.4217 | 1.8234 | 3.7861 | 0 |
| Example-1 | | | | | | | | |
| Example-2 | 9 × 8 | 49.4 | 58.2 | 3.7 | 0.2435 | 0.8264 | 3.8642 | 55.78 |
| Comparative | 9 × 8 | 49.2 | 72.79 | 9.1 | 0.8048 | 1.8691 | 3.8966 | 0 |
| Example-2 | | | | | | | | |

### Example 3

### Incomplete Cubic Shaped Abrasive Particles Made With Slurry Precursor Pre-Mix

An incomplete cubic shaped abrasive particle was formed using the same procedure as Example-1, with the exception that a production tool with cubic shaped cavities was used, resulting in particles like those illustrated in FIG. 2G and shown in FIG. 6B.

### Example 4

### Incomplete Pyramid Shaped Particles Made With Slurry Precursor Pre-Mix

An incomplete pyramid shaped abrasive particle was formed using the same procedure as Example-1, with the exception that a production tool with pyramid shaped cavities was used. The particle is illustrated in FIG. 18A, and the produced particles are illustrated in FIG. 18B.

Example-5 abrasive article comprising incomplete shaped abrasive particles made in EXAMPLE-1

A lofty, random air-laid web, having a blend of 40% F1 and 60% F2 at a weight of 695 g/m2, was formed using an equipment such as that available under the trade designation “RANDO WEBBER” commercially available from Rando Machine Company of Macedon, N.Y. The web was further needle punched in a needle loom, rolled, and a pre-bond coating having the composition set forth in Table 1 was applied to the air-laid fabric to achieve a dry add-on weight of 251 g/m2 and then curried to form a nonwoven backing. The nonwoven backing was then cut into 5-inch diameter discs for mineral coating.

3 g make resin was applied onto the nonwoven backing with a brush and then 10-11 g incomplete shaped abrasive particles made in EXAMPLE-1 was coated onto the nonwoven backing through electrostatic coater. The disc sample was then dried at 90 degree Celsius for 1 hour and then cured at 102 degree Celsius for 6 hours.

Comparative example-3 abrasive article comprising complete shaped abrasive particles made in Comparative EXAMPLE-1

A nonwoven abrasive disc was formed using the same procedure as Example-5, with the exception that the complete shaped abrasive particles made in Comparative EXAMPLE-1 was used.

### Grinding Performance Test

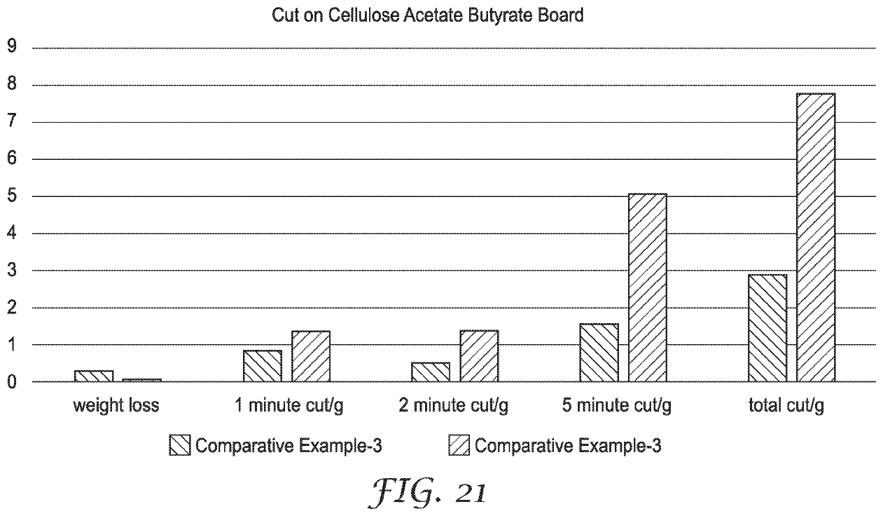

The grinding performance of the abrasive articles made in EXAMPLE-5 and Comparative Example-3 were tested on an 18-inch by 24-inch Cellulose Acetate Butyrate board (CAB., purchased from Gemini Incorporated, Cannon Falls, Minn.). The CAB board is composited of 65% Cellulose Acetate Butyrate, 20% Bis(2-ethylhexyl) adipate, and 10% additives and colorant. The nonwoven abrasive disc was attached to a Random Orbital Sander (Model 28514 from 3M company) with 6-inch (15.2 cm) backup pad, commercially available under the trade designation “HOOKIT BACKUP PAD, PART NO. 05865,” from 3M Company. The cut performance of the abrasive articles was recorded after 1-minute, 2-minute, and 5-minute grinding period. The weight loss of the abrasive article after 5-minute test was also recorded. Table-II summarizes the grinding performance of the abrasive articles. The Example-5 sample shows about 2.5× higher cut than that of the Comparative example-3 abrasive article, and the Example-5 sample shows negligible weight loss which suggested a better adhesion between the mineral particle and the backing. The Comparative example-3 sample lost about 0.3 g after 5 minutes test which suggested mineral shelled-off from the nonwoven backing. Results of the cut test are illustrated in FIG. 21.

### Example 5

### Making Curved Triangle Shaped Abrasive Trains

A piece of molded production tool with triangle shaped cavities was used. The production tool has a plurality of triangular shaped cavities with a depth of 28 mils and sides 110 mil, with an inclined side wall having a preset angle stamping slope and between the side wall and the bottom of the molds. A mold release agent, 0.2 percent peanut oil in methanol was used to coat the molding with about 0.5 mg/in\hat{ }(0.08 mg/cm\hat{ }) of peanut oil applied to the molding. The excess methanol was removed by placing sheets of the molding in an air convection oven for 5 minutes at 45° C. before use.

In the first step, the Sol-Gel Precursor pre-Mix was placed on the surface of the production tool with a putty knife and the Sol-Gel Precursor pre-Mix was forced to fill in about ⅔ volume of each triangle shaped cavities.

In the second step, the Slurry Precursor Pre-Mix was placed on the surface of the molded production tool with a putty knife and forced to fully fill the remaining spaces in each cavity.

The molded production tool filled with precursor premix was placed in an air convection oven at 45° C. for at least 45 minutes to dry. The volume of the Al-Sol-Gel Precursor pre-Mix shrank dramatically during the drying process due to dehydration (the Al-Sol-Gel Precursor pre-Mix has about 60% water by weight) and the volume of the Slurry Precursor Pre-Mix barely shrank due to its high solid content (78% or higher by weight). As a result, the precursor particle bends gradually with the progress of drying due to the internal force between the two-phase materials. Due to the weak affinity between the Al-Sol-Gel Precursor and the Slurry Precursor Pre-Mix, the two phases materials separated from each other after drying, forming two curved precursor particles.

Optional, the precursor particles can be further doped with rare earth elements according to methods described in, for example, U.S. Pat. No. 5,213,591 (Celikkaya et al.) and U.S. Pat. Appln. Publ. Nos. 2009/0165394 A1 (Culler et al.) and 2009/0169816 A1 (Erickson et al.). The precursor particles were further converted to abrasive particles through pre-firing at 750° C. for about 10 minutes and then sintered at approximately 1400° C. for 15 minutes.

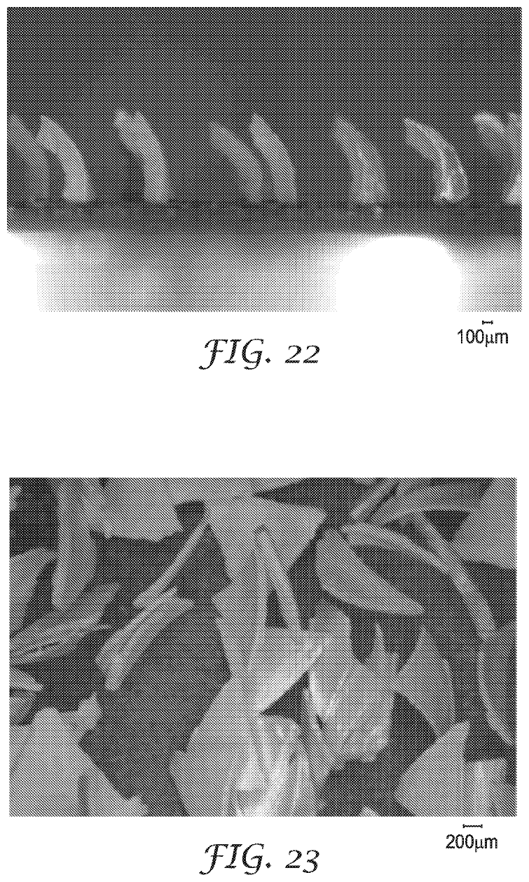

FIG. 22 shows an image of the curved sol-gel abrasive particles and FIG. 23 presents an image of the curved slurry abrasive particles.

1. An abrasive particle comprising:
an incomplete polygonal shape having a first arm and a second arm;
wherein the incomplete polygonal shape comprises a portion of the abrasive particle having a theoretical polygonal shape, and wherein at least a portion of an interior of the theoretical polygonal shape is absent; and
wherein the first arm comprises a portion of a surface area of the theoretical polygonal shape.

2. The abrasive particle of claim 1, wherein the incomplete polygonal shape comprises a vertex.

3. The abrasive particle of claim 1, and further comprising a concave surface.

4. The abrasive particle of claim 1, wherein the first arm and the second arm are substantially the same size.

5. The abrasive particle of claim 1, wherein the first arm is substantially shorter than the second arm.

6. The abrasive particle of claim 1, wherein the incomplete polygonal shape is an incomplete tetrahedron, an incomplete cube, or an incomplete pentahedron.

7. The abrasive particle of claim 1, wherein the incomplete polygonal shape comprises at least one surface with an arc-shaped edge.

8. (canceled)

9. (canceled)

10. A abrasive article comprising a plurality of particles from claim 1, the article comprising:
a backing;
wherein the plurality of particles are attached to the backing; and
wherein the abrasive article is configured to abrade a surface.

11-15. (canceled)

16. A method of manufacturing the incomplete polygonal shaped abrasive particle of claim 1, the method comprising:
filling the polygonal mold with a precursor slurry; and
drying the precursor slurry such that a precursor incomplete polygonal shaped abrasive particle is formed.

17-19. (canceled)

20. An abrasive particle precursor comprising:
a first layer comprising a first precursor composition;
a second layer comprising a second precursor composition;
wherein the first and second layers are separable along an interface between the first and second layer; and
wherein each of the first and second layers have curvature, and wherein the first and second layers are parallel to each other.

21. (canceled)

22. (canceled)

23. The abrasive particle precursor of claim 20, wherein the first or second layers is a sacrificial layer not suitable for abrasive operations.

24. The abrasive particle precursor of claim 23, wherein the sacrificial layer comprises: a polymer.

25. The abrasive particle precursor of claim 23, wherein the sacrificial layer comprises a softer material than a non-sacrificial layer.

26. The abrasive particle precursor of claim 20, wherein the first layer comprises a plurality of corners, and wherein curvature causes the plurality of corners to curve in the same direction, such that all of the plurality of corners face the same direction.

27. (canceled)

28. (canceled)

29. A method for forming a curved abrasive particle, the method comprising:
partially filling a mold cavity with a first composition layer;
partially filling a mold cavity with a second composition layer;
drying the first and second composition to form an abrasive particle precursor comprising a first precursor layer and a second precursor layer, wherein drying causes the abrasive particle precursor to develop curvature; and
wherein the first or second composition is an abrasive particle precursor material.

30. The method of claim 29, wherein drying causes the first composition to peel away at the corners of the mold.

31. The method of claim 29, wherein drying causes the first composition to peel away in the interior of the mold.

32. The method of claim 29, wherein prior to drying, the first composition and second compositions layers are planar, and wherein, after drying, each of the first and second composition layers has convex curvature.

33. (canceled)

34. The method of claim 29, wherein the abrasive particle precursor has an internal surface and an external surface and wherein the internal surface is substantially parallel to the external surface at a point along the curvature.

35. (canceled)

36. The method of claim 29, and further comprising:
processing one of the first and second abrasive particle precursors to form a curved abrasive particle.

37-40. (canceled)
